(19) United States
(12) Patent Application Publication
(10) Pub. No.: US 2026/0326504 A1
(43) Pub. Date: Oct. 22, 2026

(54) REVERSIBLE REFRIGERATION SYSTEMS

(71) Applicant: THERMO KING LLC, Minneapolis, MN (US)

(72) Inventors: Jordi GARCIA FARRAN, Barcelona (ES); Joan VILA SOLER, Terrassa (ES)

(21) Appl. No.: 19/573,035

(22) Filed: Mar. 20, 2026

(30) Foreign Application Priority Data
Mar. 21, 2025 (EP) 25165424.0

(51) Int. Cl. B60H 1/00; B60H 1/32

(52) U.S. Cl. CPC B60H 1/00885; B60H 1/00807; B60H 1/3228; B60H 2001/00942

(57) ABSTRACT

The present disclosure relates to a reversible vapour-compression refrigeration system for a multi-compartment refrigeration unit. The refrigeration system includes a refrigeration circuit including a compressor, an outdoor heat exchanger section, a first indoor heat exchanger section for a first compartment and a second indoor heat exchanger section for a second compartment. The refrigeration system also includes a controller configured to operate the refrigeration circuit in a cooling circuit direction and a heating circuit direction.

### FIELD

The present disclosure relates to reversible vapour-compression refrigeration systems for a multi-compartment refrigeration unit.

### BACKGROUND

It is known to provide a reversible vapour-compression refrigeration/heat pump system for a refrigeration unit which is operable in both a forward cycle and a reverse cycle. In the forward cycle, the vapour-compression refrigeration/heat pump system moves heat from the compartment of the unit to an external environment so as to provide cooling to the compartment. In the reverse cycle, the vapour-compression refrigeration/heat pump system moves heat from external environment to the compartment of the unit so as to provide heating to the compartment.

Implementation of a reverse cycle (e.g., a heating cycle) is challenging in the context of a multi-compartment refrigeration unit (i.e., a refrigeration unit having multiple compartments which are to be climate-controlled). The embodiments described herein have been devised with the foregoing in mind.

### SUMMARY

The disclosure includes and extends to the aspects defined in the following numbered clauses.

A1. A reversible vapour-compression refrigeration system for a multi-compartment refrigeration unit, the refrigeration system comprising:
a refrigeration circuit including a compressor, an outdoor heat exchanger section, a first indoor heat exchanger section for a first compartment and a second indoor heat exchanger section for a second compartment, the first and second indoor heat exchanger sections provided along parallel paths to each other; and
a controller configured to operate the refrigeration circuit based on a first compartment demand for heating or cooling and a second compartment demand for heating or cooling, each compartment demand determined based on respective first and second target temperatures;
wherein the controller is configured to operate the refrigeration circuit in:
   a cooling circuit direction to convey refrigerant from the compressor to the outdoor heat exchanger, and then to one or more of the first and second indoor heat exchanger sections for compartment cooling; and
   a heating circuit direction to convey refrigerant from the compressor to one or more of the first and second indoor heat exchanger sections for compartment heating, and then to the outdoor heat exchanger section;
wherein the controller is configured to operate the refrigeration system in a hybrid mode when the first compartment demand and the second compartment demand are opposites, whereby:
   one of the first and second compartment demands is a heating demand, the respective compartment is a heating compartment, and the respective indoor heat exchanger section is a heating section, and
   the other of the first and second compartment demands is a cooling demand, the respective compartment is a cooling compartment, and the respective indoor heat exchanger section is a cooling section;
wherein the controller is configured to selectively isolate the heating section by closing a control valve of the heating section, and the controller is configured to selectively isolate the cooling section by closing a control valve of the cooling section;
wherein the controller is configured to operate in the hybrid mode by alternately switching between:
   a hybrid heating sub-mode in which the controller operates the refrigeration circuit in the heating circuit direction and isolates the cooling section to bias refrigerant flow to the heating section for heating the heating compartment; and
   a hybrid cooling sub-mode in which the controller operates the refrigeration circuit in the cooling circuit direction and isolates the heating section to bias refrigerant flow to the cooling section for cooling the cooling compartment.

A2. The refrigeration system of A1, wherein the controller is configured so that:
in the hybrid heating sub-mode, the control valve of the heating section is open; and
in the hybrid cooling sub-mode, the control valve of the cooling section is open.

A3. The refrigeration system of A1 or A2, wherein the controller is configured to switch alternately between the hybrid heating sub-mode and the hybrid cooling sub-mode to switch between the heating compartment and the cooling compartment being an active heat transfer compartment, wherein the alternate switching is based on evaluating a compartment hybrid switching criterion.

The compartment which is not the active heat transfer compartment may be referred to as the inactive heat transfer compartment.

A4. The refrigeration system of A3, wherein the compartment hybrid switching criterion is defined so that switching occurs based on determining that a target temperature for the active heat transfer compartment is met.

The target temperature may be an limit of a target temperature range. The limit of the target temperature range may be a maximum of the target temperature range when switching from the hybrid heating sub-mode, and may be a minimum of the target temperature range when switching from the hybrid cooling sub-mode.

A5. The refrigeration system of A3, wherein the controller is configured to:
monitor a first offset between a monitored temperature of the first compartment and an associated first target temperature;
monitor a second offset between a monitored temperature of the second compartment and an associated second target temperature; and
wherein the compartment hybrid switching criterion is defined so that switching of the active heat transfer compartment occurs based on determining a change in the greatest of the first and second offsets.

It may be that the controller is configured to switch sub-modes so that the active heat transfer compartment is the compartment associated with the greatest of the first and second offsets.

A6. The refrigeration system of any one of A3-A5, wherein the controller is configured to commence alternate operation between the hybrid heating sub-mode and the hybrid cooling sub-mode by selecting one of the hybrid heating sub-mode and the hybrid cooling sub-mode as an initial hybrid sub-mode, wherein the controller is configured so that:
the initial hybrid sub-mode is predetermined; or
the initial hybrid sub-mode is determined based on determining the greater of a first offset between a monitored temperature of the heating compartment and an associated target temperature, and a second offset between a monitored temperature of the cooling compartment and an associated target temperature.

A7. The refrigeration system of A6, wherein the initial hybrid sub-mode is predetermined as the hybrid cooling sub-mode.

A8. The refrigeration system of A3, wherein the compartment hybrid switching criterion is defined so that one of the hybrid heating sub-mode and the hybrid cooling sub-mode is a prioritized hybrid sub-mode, and the other is a deprioritized hybrid sub-mode;
wherein the prioritized hybrid sub-mode is associated with a prioritized target temperature range and the respective compartment is a prioritized compartment, and the deprioritized hybrid sub-mode is associated with a deprioritized target temperature range and the respective compartment is a deprioritized compartment;
wherein the compartment hybrid switching criterion is defined so that:
   the controller switches from the prioritized hybrid sub-mode to the deprioritized hybrid sub-mode based on determining that a prioritized target temperature for the prioritized compartment is met;
   the controller switches from the deprioritized hybrid sub-mode to the prioritized hybrid sub-mode based on any of:
      determining that a deprioritized target temperature for the deprioritized compartment is met; and
      determining that a limit of the prioritized target temperature range is reached.

Accordingly, the compartment hybrid switching criterion prioritizes the prioritized hybrid sub-mode, and switches to the prioritized hybrid sub-mode to maintain a monitored temperature of the prioritized compartment within the prioritized target temperature range, for example even if a monitored temperature of the deprioritized compartment is not within the deprioritized target temperature range.

A9. The refrigeration system of A8, wherein the controller is configured to commence alternate operation between the prioritized hybrid sub-mode and the deprioritized hybrid sub-mode with operation in the prioritized hybrid sub-mode.

B1. A reversible vapour-compression refrigeration system for a multi-compartment refrigeration unit, the refrigeration system comprising:
a refrigeration circuit including a compressor, an outdoor heat exchanger section, a first indoor heat exchanger section for a first compartment and a second indoor heat exchanger section for a second compartment, the first and second indoor heat exchanger sections provided along parallel paths to each other;
a controller configured to operate the refrigeration circuit based on a first compartment demand for heating or cooling and a second compartment demand for heating or cooling, each compartment demand determined based on respective first and second target temperatures;
wherein the controller is configured to operate the refrigeration circuit in:
   a cooling circuit direction to convey refrigerant from the compressor to the outdoor heat exchanger section, and then to one or more of the first and second indoor heat exchanger sections for compartment cooling; and
   a heating circuit direction to convey refrigerant from the compressor to one or more of the first and second indoor heat exchanger sections for compartment heating, and then to the outdoor heat exchanger section;
   wherein the controller is configured to operate the refrigeration circuit in a dual heating mode responsive to a first compartment heating demand and a second compartment heating demand, in which the refrigeration circuit operates in the heating circuit direction and both the first and second indoor heat exchanger sections operate as condensers for heating both the first and second;
wherein the controller is configured to selectively isolate the first heat exchanger section by closing a control valve of the first heat exchanger section, and the controller is configured to selectively isolate the second heat exchanger section by closing a control valve of the second heat exchanger section;
wherein the controller is configured to operate in the dual heating mode by alternately switching between:
   a first heating sub-mode in which the controller isolates the second heat exchanger section to bias refrigerant flow to the first heat exchanger section for heating the first compartment; and
   a second heating sub-mode in which the controller isolates the first heat exchanger section to bias refrigerant flow to the second heat exchanger section for heating the second compartment.

B2. The refrigeration system of B1, wherein the controller is configured so that:
in the first heating sub-mode, the control valve of the first heat exchanger section is open; and
in the second heating sub-mode, the control valve of the second heat exchanger section is closed.

B3. The refrigeration system of B1 or B2, wherein the controller is configured to switch alternately between the first heating sub-mode and the second heating sub-mode to switch between the first compartment and the second compartment being an active heat transfer compartment, wherein the alternate switching is based on evaluating a compartment heating switching criterion.

The compartment which is not the active heat transfer compartment may be referred to as the inactive heat transfer compartment.

B4. The refrigeration system of B3, wherein the compartment heating switching criterion is defined so that switching occurs based on determining that a target temperature for the active heat transfer compartment is met.

The target temperature may be an extreme of a target temperature range, for example a maximum of the target temperature range.

B5. The refrigeration system of B3 or B4, wherein the controller is configured to:
monitor a first offset between a monitored temperature of the first compartment and an associated first target temperature;
monitor a second offset between a monitored temperature of the second compartment and an associated second target temperature; and
wherein the compartment heating switching criterion is defined so that switching of the active heat transfer compartment occurs based on determining a change in the greatest of the first and second offsets.

It may be that the controller is configured to switch sub-modes so that the active heat transfer compartment is the compartment associated with the greatest of the first and second offsets.

B6. The refrigeration system of any one of B3-B5, wherein the controller is configured to commence alternate operation between the first heating sub-mode and the second heating sub-mode by selecting one of the first heating sub-mode and the second heating sub-mode as an initial heating sub-mode, wherein the controller is configured so that:
the initial heating sub-mode is predetermined; or
the initial heating sub-mode is determined based on determining the greater of a first offset between a monitored temperature of the first compartment and an associated target temperature, and a second offset between a monitored temperature of the second compartment and an associated target temperature.

B7. The refrigeration system of any one of B3-B6, wherein the compartment heating switching criterion is defined so that one of the first heating sub-mode and the second heating sub-mode is a prioritized heating sub-mode, and the other is a deprioritized heating sub-mode;
wherein the prioritized heating sub-mode is associated with a prioritized target temperature range and the respective compartment is a prioritized compartment, and the deprioritized heating sub-mode is associated with a deprioritized target temperature range and the respective compartment is a deprioritized compartment;
wherein the compartment heating switching criterion is defined so that:
   the controller switches from the prioritized heating sub-mode to the second sub-mode based on determining that a first target temperature for the first priority compartment is met;
   the controller switches from the deprioritized heating sub-mode to the first priority sub-mode based on any of:
      determining that a second target temperature for the deprioritized compartment is met; and
      determining that a limit of the prioritized target temperature range is reached.

Accordingly, the compartment heating switching criterion prioritizes the prioritized heating sub-mode, and switches to the prioritized heating sub-mode to maintain a monitored temperature of the prioritized compartment within the prioritized target temperature range, for example even if a monitored temperature of the second priority compartment is not within the deprioritized target temperature range.

B8. The refrigeration system of B6 or B7, wherein the controller is configured to commence alternate operation between the prioritized heating sub-mode and the second priority sub-mode with operation in the prioritized heating sub-mode.

B9. The refrigeration system of any one of B1-B8, wherein the controller is configured to operate in the dual heating mode by:
operating in a simultaneous heating mode in which the both the first and second heat exchanger sections are not isolated and refrigerant flow is permitted through both of the first and second heat exchanger sections for heating the respective first and second compartments; and
commencing alternate operation between the prioritized heating sub-mode and the second priority sub-mode based on evaluating an exit criterion.

It may be that, in the simultaneous heating mode, both of the control valves of the respective heat exchanger sections (i.e. those which can be closed to isolate the respective heat exchanger sections) are open.

B10. The refrigeration system of B9, wherein the controller is configured to evaluate the exit criterion by:
determining cooling of one of the first and second compartments despite a heating demand;
determining an threshold imbalance of refrigerant flow;
monitoring a common condensing pressure for the first and second heat exchanger sections, and determining that the common condensing pressure is below a threshold corresponding to simultaneous heating of the compartments;
monitoring a refrigerant temperature, and determining that the refrigerant temperature is below a threshold corresponding to simultaneous heating of the compartments.

It may be that the pressure threshold for simultaneous heating relates to a condensing temperature for simultaneous heating of the compartments.

C1. A reversible vapour-compression refrigeration system for a multi-compartment refrigeration unit, the refrigeration system comprising:
a refrigeration circuit including a compressor, an outdoor heat exchanger section, a first indoor heat exchanger section for a first compartment and a second indoor heat exchanger section for a second compartment, the first and second indoor heat exchanger sections provided along parallel paths to each other;
a controller configured to operate the refrigeration circuit based on a first compartment demand for heating or cooling and a second compartment demand for heating or cooling, each compartment demand determined based on respective first and second target temperatures;
wherein the controller is configured to operate the refrigeration circuit in:
   a cooling circuit direction to convey refrigerant from the compressor to the outdoor heat exchanger, and then to one or more of the first and second indoor heat exchanger sections; and
   a heating circuit direction to convey refrigerant from the compressor to one or more of the first and second indoor heat exchanger sections, and then to the outdoor heat exchanger section;
wherein the controller is configured to operate the refrigeration circuit in a dual cooling mode responsive to a first compartment cooling demand and a second compartment cooling demand, in which the refrigeration circuit operates in the cooling circuit direction and both the first and second indoor heat exchanger sections operate as evaporators for cooling both the first and second compartments;
wherein the controller is configured to operate the refrigeration circuit in a dual heating mode responsive to a first compartment heating demand and a second compartment heating demand, in which the refrigeration circuit operates in the heating circuit direction and both the first and second indoor heat exchanger sections operate as condensers for heating both the first and second compartments;
wherein the first indoor heat exchanger section comprises a first heat exchanger and a first connection portion for conveying refrigerant between the first heat exchanger and the outdoor heat exchanger, and the second indoor heat exchanger section comprises a second heat exchanger and a second connection portion for conveying refrigerant between the second heat exchanger and the outdoor heat exchanger;
wherein the controller is configured to operate the refrigeration circuit so that:
   in the dual cooling mode, refrigerant flows through the first indoor heat exchanger section and the second indoor heat exchanger section in respective first and second cooling directions, so that the first and second connection portions are downstream of the first and second indoor heat exchangers, respectively;
   in the dual heating mode, refrigerant flows through the first indoor heat exchanger section and the second indoor heat exchanger section in respective first and second heating directions which oppose the respective cooling directions, so that the first and second connection portions are upstream of the first and second indoor heat exchangers, respectively; and
wherein the first and second connection portions are configured so that a flow factor along the second connection portion in the second heating direction is lower than a flow factor along the first connection portion in the first heating direction.

Accordingly, in the dual heating mode, refrigerant received by the first and second indoor heat exchanger sections from the compressor is expanded relatively more in the second connection portion, such that a condensing pressure (and therefore condensing temperature) at the second heat exchanger is relatively lower than a condensing pressure (and therefore condensing temperature) at the first heat exchanger. This permits compartment heating to occur at both heat exchangers, and avoids a situation which may occur when the first and second target temperatures are different (e.g., the first target temperature being greater than the second target temperature), whereby a common condensing pressure is established at both heat exchangers resulting in cooling for the first compartment and heating of the second compartment.

C2. A refrigeration system according to C1, wherein the second connection portion comprises two parallel branches, including a cooling direction branch for refrigerant flow in the second cooling direction, and a heating direction branch for refrigerant flow in the second heating direction; and
wherein the refrigeration circuit is configured so that a restrictor device in the heating direction branch of the second connection portion determines the flow factor along the second connection portion in the second heating direction.

The restrictor device may be a fixed flow restrictor, for example an orifice valve or capillary tube. The restrictor device may be a pressure regulator valve.

It may be that the cooling direction branch of the second connection portion includes a one-way flow control device configured to permit flow in the second cooling direction and to prevent flow in the second heating direction. For example, the one-way flow control device may be a check valve.

It may be that the heating direction branch of the second connection portion includes a one-way flow control device configured to permit flow in the second heating direction and to prevent flow in the second cooling direction. For example, the one-way flow control device may be a check valve.

It may be that the refrigeration circuit is configured so that the restrictor device in the heating direction branch determines the flow factor along the second connection portion in the second heating direction by virtue of the refrigeration system being configured to selectively close a valve along the cooling direction branch in the dual heating mode.

C3. A refrigeration system according to C2, wherein the refrigeration circuit is configured so that the restrictor device in the heating direction branch of the second connection portion determines the flow factor along the second connection portion in the second heating direction by:
the cooling direction branch comprising a one-way flow control device configured to permit flow in the second cooling direction and to prevent flow in the second heating direction, to thereby direct refrigerant flow in the second heating direction along the heating direction branch; and/or
the cooling direction branch comprising a second cooling branch flow control device configured to close in the dual heating mode to direct refrigerant flow along the second connection portion to flow along the heating direction branch.

It may be that the controller is configured to close the second cooling branch flow control device in the dual heating mode. The controller may be configured to open the second cooling branch flow control device in the dual cooling mode.

Optionally, it may be that the heating direction branch of the second connection portion comprises a one-way flow control device configured to permit flow in the second heating direction and to prevent flow in the second cooling direction. Optionally, it may be that the heating direction branch of the second connection portion comprises a second heating branch flow control device configured to open in the dual heating for refrigerant flow along the second connection portion along the heating direction branch.

C4. A refrigeration system according to C2 or C3, configured so that the flow factor along the second connection portion in the second heating direction in the dual heating mode is different from a flow factor along the second connection portion in the second cooling direction in the dual cooling mode.

The flow factor corresponds to non-zero refrigerant flow operating conditions. For example, where control valves are provided that may selectively permit or prevent flow, the flow factor is determined for operating conditions at which refrigerant flows in the respective direction (e.g., is not prevented by a control valve).

C5. A refrigeration system according to any one of C2-C4, wherein the first connection portion comprises two parallel branches, including a cooling direction branch for refrigerant flow in the first cooling direction, and a heating direction branch for refrigerant flow in the first heating direction;
wherein the refrigeration system is configured so that the flow factor along the first connection portion in the first heating direction in the dual heating mode is different from a flow factor along the first connection portion in the first cooling direction in the dual cooling mode.

C6. A refrigeration system according to C5, wherein the refrigeration system is configured so that the heating branch of the first connection portion determines a flow factor along the first connection portion in the first heating direction, and so that the cooling branch of the first connection portion determines a flow factor along the first connection portion in the first cooling direction, by:
the cooling direction branch comprising a one-way flow control device configured to permit flow in the first cooling direction and to prevent flow in the first heating direction, to thereby direct refrigerant flow in the first heating direction along the heating direction branch; and/or
the heating direction branch comprising a one-way flow control device configured to permit flow in the first heating direction and to prevent flow in the first cooling direction, to thereby direct refrigerant flow in the first cooling direction along the cooling direction branch; and/or
the cooling direction branch comprising a first cooling branch flow control device configured to close in the dual heating mode to direct refrigerant flow along the first connection portion to flow along the heating direction branch; and/or
the heating direction branch comprising a first heating branch flow control device configured to close in the dual cooling mode to direct refrigerant flow along the first connection portion to flow along the cooling direction branch.

C7. A refrigeration system according to C5 or C6, wherein the heating direction branch of the first connection portion comprises:
a restrictor device that determines the flow factor along the first connection portion in the first heating direction; and
optionally a one-way flow control device configured to permit flow in the first heating direction and to prevent flow in the first cooling direction.

Otherwise, the heating direction branch of the first connection portion may not have a restrictor device configured to determine a flow factor along the first connection portion in the heating direction. For example, the heating direction branch of the first connection portion may be free of a restrictor device. The heating direction branch of the first connection portion may nevertheless comprise other elements, for example a one-way flow control device (e.g., a check valve), or a flow control device (e.g., a solenoid valve).

C8. A refrigeration system according to any of C5-C7, wherein the heating direction branch of the first connection portion comprises a first heating branch flow control device;
wherein the controller is configured to open the first heating branch flow control device in the dual heating mode so that refrigerant flows along the cooling direction branch of the first connection portion in the first heating direction; and
wherein the controller is configured to close the first heating branch flow control device in the dual cooling mode, so that refrigerant flow along the first connection portion is along the cooling direction branch.

It may be that, in the absence of any one-way flow control devices in the heating direction branch and the cooling direction branch of the first connection portion, a flow factor along the cooling branch is lower than a flow factor along the heating branch, such that opening of the first heating branch flow control device biases refrigerant flow along the heating direction branch.

C9. A refrigeration system according to any of C2-C8, wherein the cooling direction branch of the second connection portion comprises a second cooling branch flow control device;
wherein the controller is configured to open the second cooling branch flow control device in the dual cooling mode so that refrigerant flows along the cooling direction branch of the second connection portion in the second cooling direction; and
wherein the controller is configured to close the second cooling branch flow control device in the dual heating mode so that refrigerant flow along the second connection portion is along the second heating direction branch.

C10. A refrigeration system according to any one of C1 to C9, wherein the first and second connection portions are configured so that a flow factor along the first connection portion in the first cooling direction is lower than a flow factor along the second connection portion in the second cooling direction.

Accordingly, in the dual cooling mode, an evaporation pressure at the first heat exchanger may be elevated from a suction pressure at which refrigerant is returned to the compressor by relatively more than a corresponding evaporation pressure at the second heat exchanger. In other words, the evaporation pressure at the first heat exchanger may be greater than the evaporation pressure at the second heat exchanger, by virtue of there being a greater pressure drop to a common suction pressure over the first connection portion than over the second connection portion, owing to the lower flow factor on the first connection portion.

C11. A refrigeration system according to C10, wherein the first connection portion comprises two parallel branches, including a cooling direction branch for refrigerant flow in the first cooling direction, and a heating direction branch for refrigerant flow in the first heating direction; and
wherein the refrigeration circuit is configured so that a restrictor device in the cooling direction branch of the first connection portion determines the flow factor along the first connection portion in the first cooling direction.

The restrictor device may be a fixed flow restrictor, for example an orifice valve or capillary tube. The restrictor device may be a pressure regulator valve.

It may be that the heating direction branch of the first connection portion includes a one-way flow control device configured to permit flow in the first heating direction and to prevent flow in the first cooling direction. For example, the one-way flow control device may be a check valve.

It may be that the cooling direction branch of the first connection portion includes a one-way flow control device configured to permit flow in the first cooling direction and to prevent flow in the first heating direction. For example, the one-way flow control device may be a check valve.

It may be that the refrigeration circuit is configured so that the restrictor device in the cooling direction branch determines the flow factor along the first connection portion in the first cooling direction by virtue of the refrigeration system being configured to selectively close a valve along the heating direction branch in the dual cooling mode.

C12. A refrigeration system according to C11, wherein the refrigeration circuit is configured so that the restrictor device in the cooling direction branch of the first connection portion determines the flow factor along the first connection portion in the first cooling direction by:
the heating direction branch comprising a one-way flow control device configured to permit flow in the first heating direction and to prevent flow in the first cooling direction, to thereby direct refrigerant flow in the first cooling direction along the cooling direction branch; and/or
the heating direction branch comprising a flow control device configured to close in the dual cooling mode to direct refrigerant flow along the first connection portion to flow along the cooling direction branch.

It may be that the controller is configured to close the flow control device of the heating direction branch of the first connection portion in the dual cooling mode. The controller may be configured to open the flow control device of the heating direction branch of the first connection portion in the dual heating mode.

Optionally, it may be that the cooling direction branch of the first connection portion comprises a one-way flow control device configured to permit flow in the first cooling direction and to prevent flow in the first heating direction. Optionally, it may be that the cooling direction branch of the first connection portion comprises a flow control device configured to open in the dual cooling mode for refrigerant flow along the first connection portion along the cooling direction branch.

It may be that the flow factor along the first connection portion in the first cooling direction in the dual cooling mode is different from a flow factor along the first connection portion in the first heating direction in the dual heating mode.

The flow factor corresponds to non-zero refrigerant flow operating conditions. For example, where control valves are provided that may selectively permit or prevent flow, the flow factor is determined for operating conditions at which refrigerant flows in the respective direction (e.g., is not prevented by a control valve).

C13. A refrigeration system according to any one of C1-C12, wherein the first connection portion comprises two parallel branches, including a cooling direction branch for refrigerant flow in the first cooling direction, and a heating direction branch for refrigerant flow in the first heating direction;
wherein the second connection portion comprises two parallel branches, including a cooling branch for refrigerant flow in the second cooling direction, and a heating direction branch for refrigerant flow in the second heating direction;
wherein a restrictor device in the heating direction branch of the second connection portion determines the flow factor along the second connection portion in the second heating direction;
wherein a restrictor device in the cooling direction branch of the second connection portion determines a flow factor along the second connection portion in the second cooling direction, which is higher than a flow factor along the first connection portion in the first cooling direction;
wherein a restrictor device in the cooling direction branch of the first cooling connection branch determines the flow factor along the first connection portion in the first cooling direction; and
wherein a restrictor device in the heating direction branch of the first cooling connection branch determines the flow factor along the first connection portion in the first heating direction.

C14. A refrigeration system according to any one of C1-C13, comprising:
a first isolating flow control device configured to selectively permit flow through the first indoor heat exchanger section, and to selectively prevent flow through the first indoor heat exchanger section to isolate the first indoor heat exchanger section; and
   a second isolating flow control device configured to selectively permit flow through the second indoor heat exchanger section, and to selectively prevent flow through the second indoor heat exchanger section to isolate the first indoor heat exchanger section;
   optionally wherein each of the first and second isolating flow control devices are outside of any parallel branches of the respective connecting path.

C15. A refrigeration system according to C14, wherein the controller is configured to selectively isolate one of the first and second indoor heat exchanger sections in the dual heating mode using the respective isolating flow control device, based on determining a demand inversion event corresponding to cooling of one of the first and second compartments despite a demand for heating.

C16. The refrigeration system according to any one of C1-C15, wherein the first target temperature is higher than the second target temperature.

D1. A reversible vapour-compression refrigeration system for a multi-compartment refrigeration unit, the refrigeration system comprising:
a refrigeration circuit including a compressor, an outdoor heat exchanger section, a first indoor heat exchanger section for a first compartment and a second indoor heat exchanger section for a second compartment, the first and second indoor heat exchanger sections provided along parallel paths to each other;
a controller configured to operate the refrigeration circuit based on a first compartment demand for heating or cooling and a second compartment demand for heating or cooling, each compartment demand determined based on respective first and second target temperatures;
wherein the controller is configured to operate the refrigeration circuit in:
   a cooling circuit direction to convey refrigerant from the compressor to the outdoor heat exchanger, and then to one or more of the first and second indoor heat exchanger sections; and
   a heating circuit direction to convey refrigerant from the compressor to one or more of the first and second indoor heat exchanger sections, and then to the outdoor heat exchanger section;
wherein the controller is configured to operate the refrigeration circuit in a dual cooling mode responsive to a first compartment cooling demand and a second compartment cooling demand, in which the refrigeration circuit operates in the cooling circuit direction and both the first and second indoor heat exchanger sections operate as evaporators for cooling both the first and second compartments;
wherein the controller is configured to operate the refrigeration circuit in a dual heating mode responsive to a first compartment heating demand and a second compartment heating demand, in which the refrigeration circuit operates in the heating circuit direction and both the first and second indoor heat exchanger sections operate as condensers for heating both the first and second compartments;
wherein the first indoor heat exchanger section comprises a first heat exchanger and a first connection path for conveying refrigerant between the first heat exchanger and the outdoor heat exchanger, and the second indoor heat exchanger section comprises a second heat exchanger and a second connection portion for conveying refrigerant between the second heat exchanger and the outdoor heat exchanger;
wherein the controller is configured to operate the refrigeration circuit so that:
   in the dual cooling mode, refrigerant flows through the first indoor heat exchanger section and the second indoor heat exchanger section in respective first and second cooling directions, so that the first and second connection portions are upstream of the first and second indoor heat exchangers, respectively;
   in the dual heating mode, refrigerant flows through the first indoor heat exchanger section and the second indoor heat exchanger section in respective first and second heating directions which oppose the respective cooling directions, so that the first and second connection portions are downstream of the first and second indoor heat exchangers, respectively; and
wherein the first connection portion comprises a first expansion valve for controlling expansion of refrigerant provided to the first heat exchanger in the first cooling direction, and the second connection portion comprises a second expansion valve for controlling expansion of refrigerant provided to the second heat exchanger in the second cooling direction;
wherein the second connection portion comprises a bypass control valve on an expansion bypass line provided in parallel with the respective expansion valve;
wherein the controller is configured to close the bypass control valve in the dual heating mode to inhibit refrigerant flow through the second heat exchanger section and bias refrigerant flow to the first heat exchanger section.

D2. The refrigeration system according to D1, wherein the first target temperature is higher than the second target temperature.

D3. The refrigeration system according to D1 or D2, wherein the second expansion valve is configured to permit a restricted flow of refrigerant along the second connection portion in the dual heating mode, for simultaneous heating of the first and second compartments.

D4. The refrigeration system according to any one of D1-D3, wherein the expansion bypass line of the second connection portion comprises a one-way valve configured to permit refrigerant flow in the heating direction, and to prevent flow in the cooling direction.

D5. The refrigeration system according to any one of D1-D4, wherein the controller is configured to operate the refrigeration circuit in:
a first heating mode in which a control valve of the second heat exchanger section is closed to isolate the second heat exchanger section and a control valve of the first heat exchanger section is open to permit refrigerant flow through the first heat exchanger section in the first heating direction; and
a second heating mode in which the control valve of the first heat exchanger section is closed to isolate the first heat exchanger section and the control valve of the second heat exchanger section is open to permit refrigerant flow through the second heat exchanger section in the second heating direction.

D6. The refrigeration system according to D5, wherein the controller is configured to open the bypass control valve of the second connection portion in the second heating mode.

D7. The refrigeration system of D5 or D6, wherein the controller is configured to operate the refrigeration circuit in the first heating mode in response to a first compartment heating demand in the absence of a second compartment heating demand; and
wherein the controller is configured to operate the refrigeration circuit in the second heating mode in response to a second compartment heating demand in the absence of a first compartment heating demand.

### BRIEF DESCRIPTION OF THE DRAWINGS

FIG. 1 shows a vehicle comprising a transport refrigeration system;

FIG. 2 shows a first example reversible vapour-compression refrigeration system suitable for use with the vehicle of FIG. 1, the first example reversible vapour-compression refrigeration system comprising a refrigeration circuit, the refrigeration circuit being operated in a cooling circuit direction;

FIG. 3 shows the first example reversible vapour-compression refrigeration system of FIG. 2, but with the refrigeration circuit being operated in a heating circuit direction; and

FIG. 4 shows an example method of operating the refrigeration circuit of the first example reversible vapour-compression refrigeration system of FIGS. 2 and 3;

FIG. 5 shows another example method of operating the refrigeration circuit of the first example reversible vapour-compression refrigeration system of FIGS. 2 and 3;

FIG. 6 shows a second example reversible vapour-compression refrigeration system suitable for use with the vehicle of FIG. 1, the second example reversible vapour-compression refrigeration system comprising a refrigeration circuit, the refrigeration circuit being operated in a cooling circuit direction;

FIG. 7 shows the second example reversible vapour-compression refrigeration system of FIG. 6, but with the refrigeration circuit being operated in a heating circuit direction;

FIG. 8 shows a third example reversible vapour-compression refrigeration system suitable for use with the vehicle of FIG. 1, the third example reversible vapour-compression refrigeration system comprising a refrigeration circuit, the refrigeration circuit being operated in a cooling circuit direction;

FIG. 9 shows the third example reversible vapour-compression refrigeration system of FIG. 8, but with the refrigeration circuit being operated in a heating circuit direction; and

FIG. 10 shows an example method of operating the refrigeration circuit of the example reversible vapour-compression refrigeration systems of FIGS. 6 to 9.

FIG. 11 is a highly schematic diagram of a machine-readable medium having stored thereon a computer program.

### DETAILED DESCRIPTION

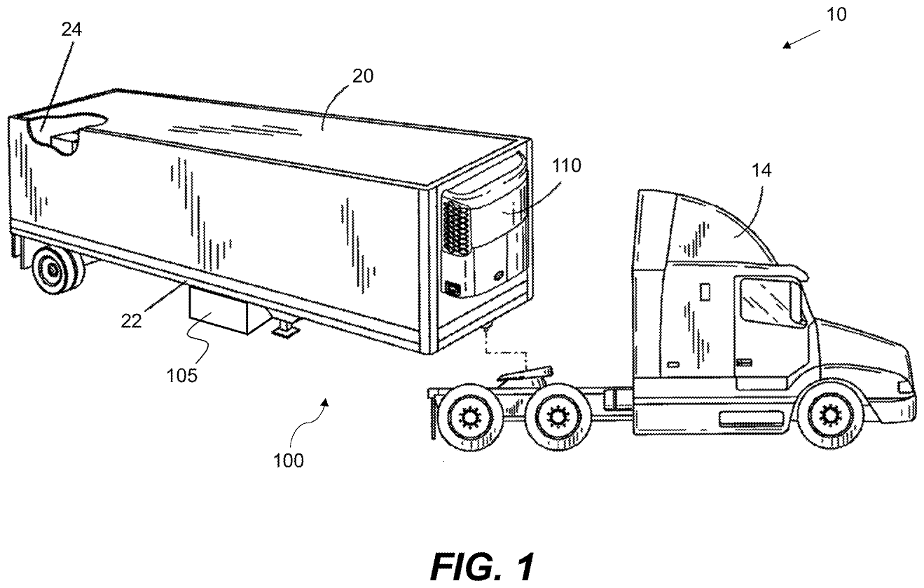

FIG. 1 shows a vehicle 10 comprising a transport refrigeration unit 20. In the example of FIG. 1, the transport refrigeration unit 20 forms a part of an over-the-road refrigerated semi-trailer having a structure 22 supporting (or forming) a climate-controlled space 24 which is configured to be cooled and/or heated by a reversible vapour-compression refrigeration system (RVCRS) 110. The climate-controlled space 24 takes the form of multiple compartments (not shown by FIG. 1), and so the transport refrigeration unit 20 is a multi-compartment refrigeration unit 20. The structure 22 includes a chassis. The vehicle 10 comprises an electrical apparatus 100 which includes various components disposed within an under-chassis box 105. In some examples, one or more components of the electrical apparatus 100 may be integrated or incorporated into the RVCRS 110. The structure 22 supports the TRU 110 and the under-chassis box 105. The vehicle 10 further comprises a tractor unit 14 removably couplable to the trailer. Although FIG. 1 shows a tractor and semi-trailer configuration, the disclosure applies equally to other configurations of a transport refrigeration unit 20, including for example an integrated truck (with a climate-controlled space mounted to a vehicle), and a temperature controlled container (e.g. for ocean, rail or truck-mounted transport, or for air transport), any of which may have multiple compartments

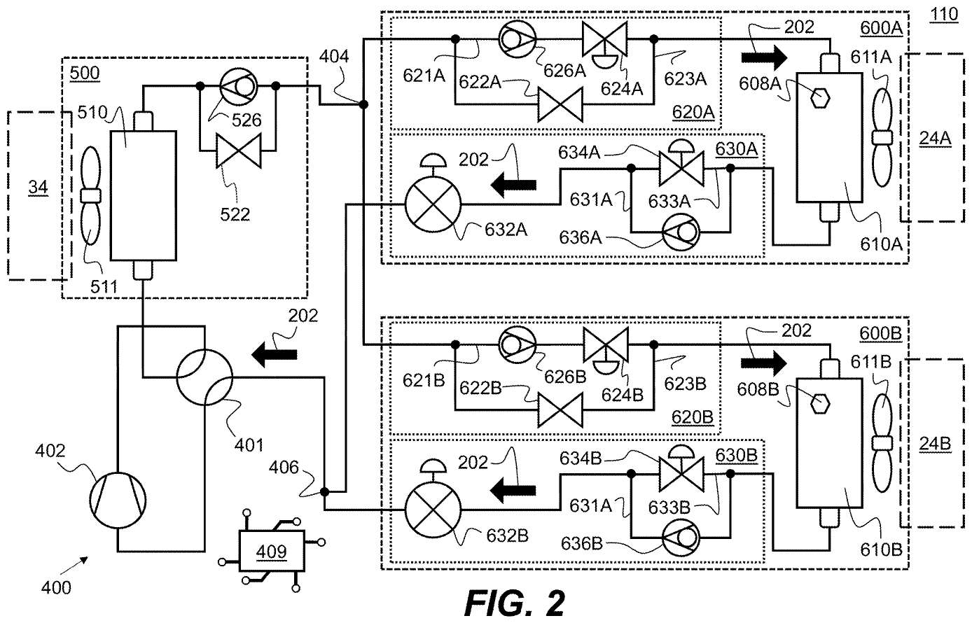

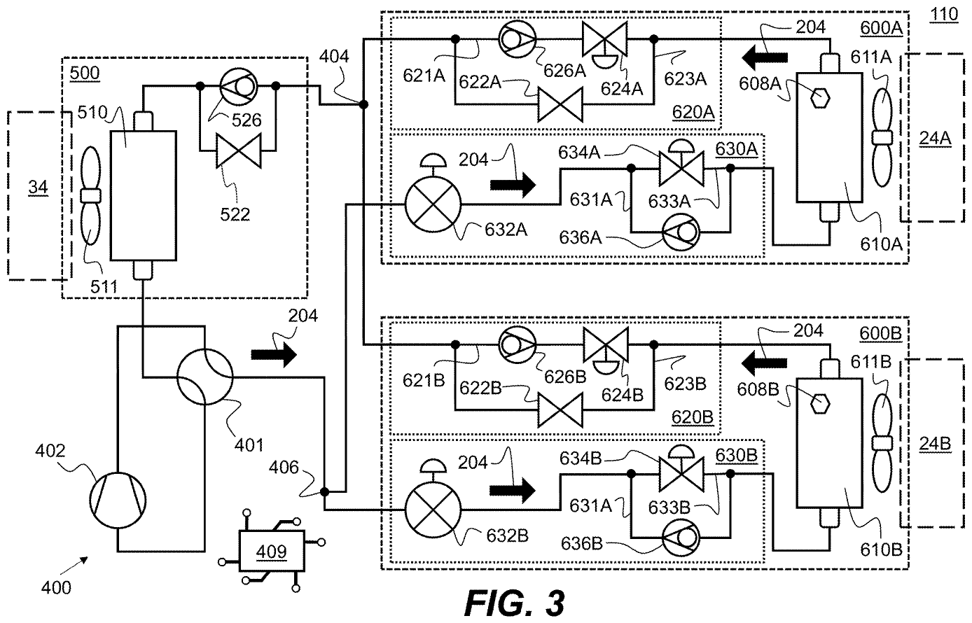

FIGS. 2 and 3 are diagrams of a first example RVCRS 110 suitable for use within the vehicle 10 and the multi-compartment refrigeration unit 20 of FIG. 1, or other configurations of transport refrigeration unit. The RVCRS 110 comprises a refrigeration circuit 400. In turn, the refrigeration circuit 400 includes a four-way valve 401, a compressor 402, an outdoor heat exchanger section 500, a first indoor heat exchanger section 600A, a second indoor heat exchanger section 600B and a controller 409.

The outdoor heat exchanger section 500 comprises an outdoor heat exchanger 510 which is provided for heat exchange with an external environment 34 (e.g., an ambient environment external to the multi-compartment refrigeration unit 20). The first indoor heat exchanger section 600A comprises a first indoor heat exchanger 610A which is provided for heat exchange with a first compartment 24A of the climate-controlled space 24. Similarly, the second indoor heat exchanger section 600B comprises a second indoor heat exchanger 610B which is provided for heat exchange with a second compartment 24B of the climate-controlled space 24. Each heat exchanger 510, 610A, 610B is provided with a respective fan 511, 611A, 611B for the promotion of convective heat transfer with the relevant thermal medium (i.e., the external environment 34, the first compartment 24A, and the second compartment 24B, respectively) by driving air over the corresponding heat exchanger 510, 610A, 610B. As will be appreciated by those skilled in the art, each heat exchanger 510 is operable as either an evaporator or a condenser within the refrigeration circuit 400.

The first and second heat exchanger sections 600A, 600B are fluidically connected in parallel with each other to the outdoor heat exchanger section 500 at primary and secondary junctions 404, 406 within the refrigeration circuit 400. The outdoor heat exchanger section 500 is connected to the secondary junction 406 via the four-way valve 401. When the refrigeration circuit 400 is operated in a cooling circuit direction as shown by arrows 202 on FIG. 2, the four-way valve 401 fluidically connects a suction side of the compressor 402 to the secondary junction 406 and fluidically connects a discharge side of the compressor 402 to the outdoor heat exchanger 510. Contrastingly, when the refrigeration circuit 400 is operated in a heating circuit direction as shown by arrows 204 FIG. 3, the four-way valve 401 fluidically connects the suction side of the compressor 402 to the outdoor heat exchanger 510 and fluidically connects the discharge side of the compressor 402 to the secondary junction 406. Other valve arrangements can be provided to provide the same effect of reversing the circuit direction for cooling and heating.

The outdoor heat exchanger section 500 further comprises a heating expansion valve (XV) 522 (which may be a thermal expansion valve/TXV or an electronic expansion valve/EXV) fluidically coupled in parallel with an outdoor section one-way valve 526. The outdoor section one-way valve 526 is biased such that it permits flow therethrough along the cooling circuit direction 202 but prevents flow therethrough along the heating circuit direction 204. Accordingly, when the refrigeration circuit 400 is operated in the heating circuit direction 204, refrigerant flow is directed through the heating XV 522 before being supplied to the outdoor heat exchanger 510.

Each indoor heat exchanger section 600A, 600B comprises a primary connection portion 620A, 620B extending between the respective heat exchanger 610A, 610B and the primary junction 404. As will be discussed below, the primary connection portions 620A and 620B are upstream of the respective heat exchangers 610A, 610B in the cooling direction 202, and downstream of the respective heat exchangers 610A, 610B in the heating direction 204. The primary connection portion 620A of the first indoor heat exchanger section 600A (i.e., the first primary connection portion 620A) is configured to convey refrigerant between the first indoor heat exchanger 610A and the outdoor heat exchanger 510 via the primary junction 404. The primary connection portion 620B of the second indoor heat exchanger section 600B (i.e., the second primary connection portion 620B) is configured to convey refrigerant between the second indoor heat exchanger 610B and the outdoor heat exchanger 510 via the primary junction 404.

In the first example RVCRS 110 shown by FIGS. 2 and 3, the primary connection portion 620A, 620B of each indoor heat exchanger section 600A, 600B comprises a primary one-way valve 626A, 626B and a primary control valve 624A, 624B (e.g., a solenoid-actuated primary control valve 624A, 642B) fluidically connected in series with one another along a primary upper branch 621A. The primary connection portion 620A, 620B of each indoor heat exchanger section 600A, 600B also comprises a cooling expansion valve (XV) 622A, 622B (which may be a thermal expansion valve/TXV or an electronic expansion valve/EXV) fluidically coupled in parallel with the primary one-way valve 626A, 626B and the primary control valve 624A, 624B along a primary lower branch 623A, 623B. References to “upper” and “lower” branches can interchangeably be considered as “first” and “second” branches. In use, the action of the primary one-way valve 626A, 262B inhibits (e.g., prevents) flow of refrigerant along the primary upper branch 621A, 621B while the refrigerant circuit 400 is operated in the cooling circuit direction, and thus refrigerant preferentially flows along the parallel primary lower branch 623A, 623B for expansion at the cooling expansion valve 622A, 622B.

Further, each indoor heat exchanger section 600A, 600B comprises a secondary connection portion 630A, 630B extending between the respective heat exchanger 610A, 610B and the secondary junction 406. As will be discussed below, the secondary connection portions 630A and 630B are upstream of the respective heat exchangers 610A, 610B in the heating direction 204, and downstream of the respective heat exchangers 610A, 610B in the cooling direction 202. In this example, the secondary connection portion 630A of the first indoor heat exchanger section 600A (i.e., the first secondary connection portion 630A) is configured to convey refrigerant between the first indoor heat exchanger 610A and the outdoor heat exchanger 510 via the secondary junction 406, the four-way valve 401 and the compressor 402. Likewise, the secondary connection portion 630B of the second indoor heat exchanger section 600B (i.e., the second secondary connection portion 630B) is configured to convey refrigerant between the secondary indoor heat exchanger 610B and the outdoor heat exchanger 510 via the secondary junction 406, the four-way valve 401 and the compressor 402.

In the first example RVCRS 110 shown by FIGS. 2 and 3, the secondary connection portion 630A, 630B of each indoor heat exchanger section 600A, 600B comprises a secondary control valve 632A, 632B (e.g., a solenoid-actuated secondary control valve 632A, 632B), a pressure regulating valve 634A, 634B and a secondary one-way valve 636A, 636B. The pressure regulating valve 634A, 634B and the secondary one-way valve 636A, 636B are fluidically connected in parallel with one another, and the secondary control valve 632A, 632B is fluidically connected in series with the pressure regulating valve 634A, 634B as well as the secondary one-way valve 636A, 636B. Specifically, the secondary one-way valve 636A, 636B is disposed on a secondary lower branch 631A, 631B while the pressure regulating valve 634A, 634B is disposed on a secondary upper branch 633A, 633B parallel with the secondary lower branch 631A, 631B. As above, reference to “upper” and “lower” branches can interchangeably be defined as “first” and “second” branches. In use, the action of the secondary one-way valve 636A, 636B inhibits (e.g., prevents) flow of refrigerant along the secondary lower branch 631A, 631B while the refrigerant circuit 400 is operated in the cooling circuit direction 202, and thus refrigerant preferentially flows along the secondary upper branch 633A, 633B.

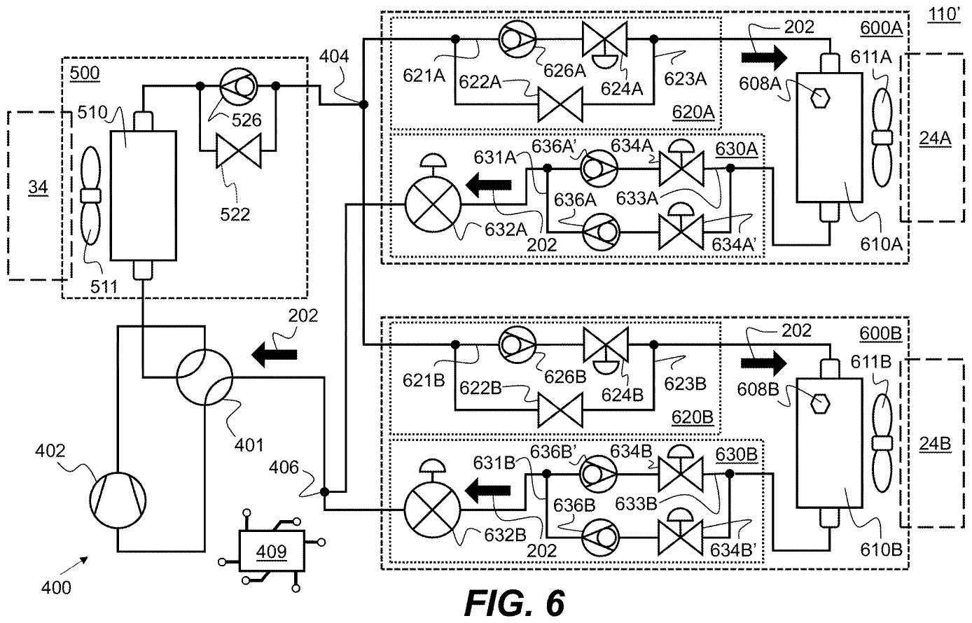

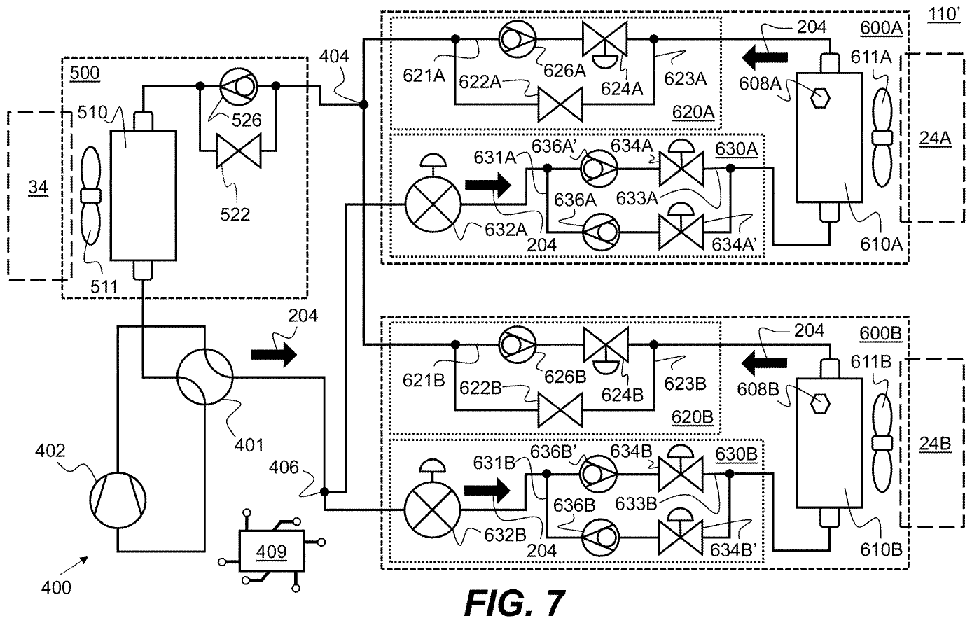

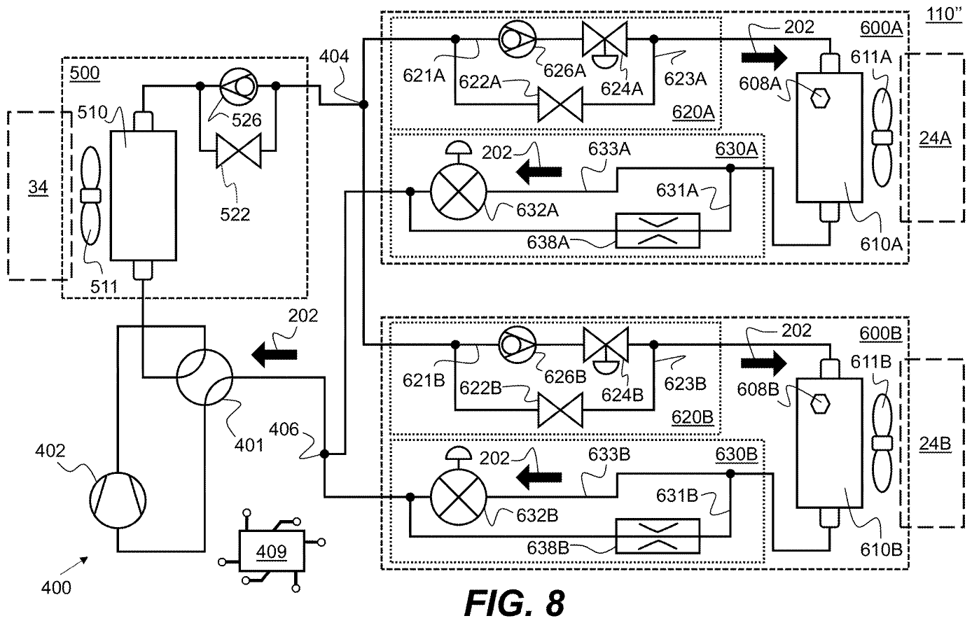

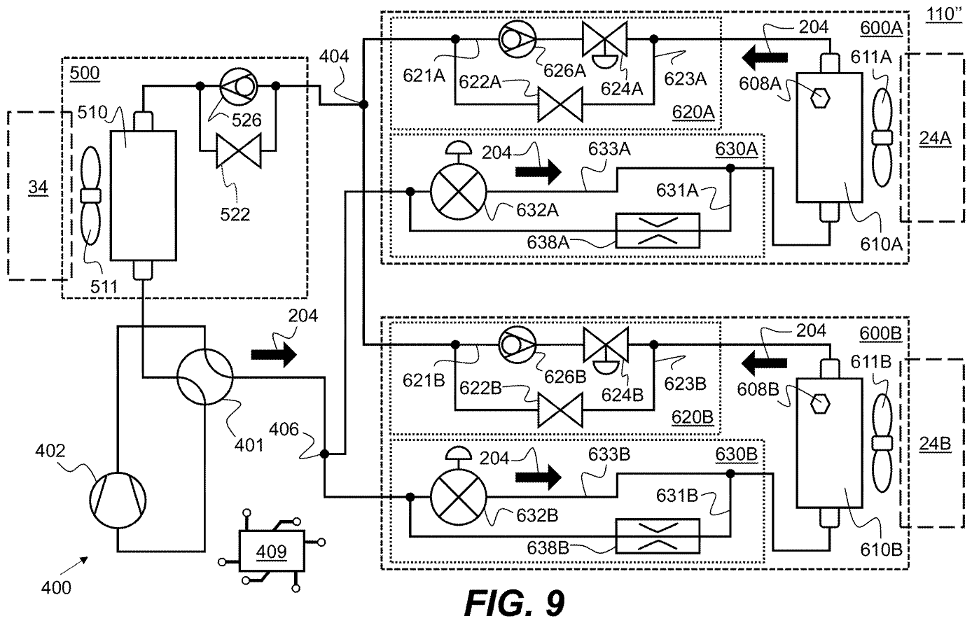

Each branch 631A, 631B, 633A, 633B is configured to be either a heating direction branch or a cooling direction branch in the respective indoor heat exchanger section 600A, 600B. Namely, in use, whichever branch 631A, 631B, 633A, 633B that conveys all or a majority of refrigerant through the secondary connection portion 630A, 630B when the refrigeration circuit 400 is operating in the heating circuit direction 204 is referred to as the heating direction branch whereas whichever branch 631A, 631B, 633A, 633B that conveys all or a majority of refrigerant through the secondary connection portion 630A, 630B when the refrigeration circuit 400 is operating in the cooling circuit direction 202 is referred to as the cooling direction branch. The cooling direction branch of each secondary connection portion 630A, 630B (i.e., the secondary cooling direction branch) is therefore for refrigerant flow therethrough in a respective first and second cooling direction, each of which correspond to the cooling circuit direction 202. Similarly, the heating direction branch of each secondary connection portion 630A, 630B (i.e., the secondary heating direction branch) is therefore for refrigerant flow therethrough in a respective first and second heating direction, each of which correspond to the heating circuit direction 204. Accordingly, the first and second heating directions oppose the first and second cooling directions. From another perspective, each cooling direction branch of each connection portion is the branch which is configured to inhibit (e.g., prevent) refrigerant flow in the heating direction, and the heating direction branch of each connection portion is the branch which is configured to inhibit (e.g., prevent) refrigerant flow in the cooling direction. The skilled person may identify which branch 631A, 631B, 633A, 633B is configured to be the heating direction branch and the cooling direction branch without observing the refrigeration circuit 400 in use. As an example, if the branches 631A, 631B, 633A, 633B each comprise one-way valves 636A, 636B, 636A′, 636B′ (as in FIGS. 6 and 7), the biasing (e.g., directionality) of the one-way valves 636A, 636B, 636A′, 636B′ enable the skilled person to identify which branch is a cooling direction branch and which branch is a heating direction branch. As another example, if only one of the branches 631A, 631B, 633A, 633B in each secondary connection portion 630A, 630B comprises a control valve (as in FIGS. 8 and 9), the branches comprising the control valve(s) 632A, 632B are identifiable as the cooling direction branches whereas the branches not comprising the control valve(s) 632A, 632B are identifiable as the heating direction branches.

Additionally, each indoor heat exchanger section 600A, 600B comprises an air temperature sensor 608A, 608B configured to monitor a compartment temperature, for example of air which is driven towards the respective indoor heat exchanger 610A, 610B by the corresponding fan 611A, 611B (e.g., a return air temperature, RAT). It will be appreciated that the temperature of the air driven towards the indoor heat exchanger 610A, 610B by the fan 611A, 611B corresponds to a temperature within the respective compartment 24A, 24B. Other compartment temperatures may be used, for example a supply air temperature or other temperature corresponding to an air temperature in the compartment.

The controller 409 is configured to selectively (e.g., alternately) operate the refrigeration circuit 400 in the cooling circuit direction 202 shown by FIG. 2 and the heating circuit direction 204 shown by FIG. 3 by controlling (e.g., actuating) the four-way valve 401 or any equivalent valve arrangement to implement a reversible flow in the refrigeration circuit. When the refrigeration circuit 400 is operated in the cooling circuit direction 202, refrigerant is conveyed from the compressor 402 to the outdoor heat exchanger 510 and then to the primary junction 404 before being conveyed to the first and/or second indoor heat exchanger section 600A, 600B for cooling of the respective compartments 24A, 24B (e.g., compartment cooling). On the other hand, when the refrigeration circuit 400 is operated in the heating circuit direction 204, refrigerant is conveyed from the compressor 402 to the secondary junction 406 and then to the first and/or second indoor heat exchanger section 600A, 600B for heating of the respective compartments 24A, 24B (e.g., compartment heating) before being conveyed to the outdoor heat exchanger 510 via the primary junction 404.

Generally, the controller 409 is configured to operate the refrigeration circuit 400 based on a demand for heating or cooling of the first compartment 24A (hereinafter referred to as a first compartment demand) and also based on a demand for heating or cooling of the second compartment 24B (hereinafter referred to as a second compartment demand). The first and second compartment demands may be either a heating demand for heating of the relevant compartment 24A, 24B or a cooling demand for cooling of the relevant compartment 24A, 24B. The first and second compartment demands may be determined based on first and second target temperatures, respectively. Namely, each compartment demand may be based on a difference between the respective target temperature and the RAT monitored by the air temperature sensor 608A, 608B of the respective indoor heat exchanger section 600A, 600B (or other compartment temperature). If the target temperature is greater than the RAT, the compartment demand may be determined to be a heating demand. Conversely, if the target temperature is less than the RAT, the compartment demand may be determined to be a cooling demand. The first and second target temperatures may be predetermined, and it may be that the first target temperature is higher than the second target temperature.

If either of the first and second compartment demands is a heating demand, the relevant compartment 24A, 24B may be referred to as a heating compartment 24A, 24B and the indoor heat exchanger section 600A, 600B thereof may be referred to as a heating section 600A, 600B. In use, the indoor heat exchanger 610A, 610B of the or each heating compartment 24A, 24B functions as a condenser while the outdoor heat exchanger 510 functions as an evaporator. Conversely, if either of the first and second compartment demands is a cooling demand, the relevant compartment 24A, 24B may be referred to as a cooling compartment 24A, 24B and the indoor heat exchanger section 600A, 600B thereof may be referred to as a cooling section 600A, 600B. In use, the indoor heat exchanger 610A, 610B of the or each cooling compartment 24A, 24B functions as an evaporator while the outdoor heat exchanger 510 functions as a condenser.

The controller 409 may also be configured to monitor a first offset between a monitored temperature of the first compartment 24A (e.g., the RAT of the first compartment 24A) and the first target temperature and also to monitor a second offset between a monitored temperature of the second compartment 24B (e.g., the RAT of the second compartment 24B) and the second target temperature.

The controller 409 is also configured to actuate the primary control valve 624A, 624B and the secondary control valve 632A, 632B of each indoor heat exchanger section 600A, 600B. More specifically, the controller 409 is configured to selectively isolate the first indoor heat exchanger section 600A by closing at least one of the control valves 624A, 632A thereof. Likewise, the controller 409 is configured to selectively isolate the second indoor heat exchanger section 600B by closing at least one of the control valves 624B, 632B thereof.

As discussed elsewhere herein, in some examples isolation of a heat exchanger section may occur by control of one control valve of the respective section, and other control valves as shown in the example drawings may not be necessary. For example, one or more of the heat exchanger sections may only have the primary control valve 624A, 624B and no secondary control valve 632A, 632B as described above, or may only have the secondary control valve 632A, 632B and no primary control valve 624A, 624B. When there is no secondary control valve 632A, 632B, closure of the primary control valve 624A, 624 on the secondary connection portion to isolate the respective heat exchanger section 600A, 600A when operating in the heating circuit direction inhibits flow through the respective heat exchanger section to bias flow to the other heat exchanger section, but a relatively low flow of refrigerant in the heating direction may be permitted through the respective primary lower branch 623A, 623B through the cooling expansion valve 622A, 622B. The same applies when a secondary control valve 632A, 632B as described above is provided in the respective heat exchanger section, but is controlled to be open.

In examples where a control valve 624A, 624B is provided on a branch (e.g. the primary upper branch 621A, 621B) of a connection portion (e.g. the primary connection portion 620A, 620B) in parallel with an expansion valve 622A for controlling expansion of refrigerant provided the respective heat exchanger section in the cooling direction (e.g., the expansion valve 622A, 622B on the primary lower branch 623A, 623B), the respective control valve 624A, 624B may be referred to as a bypass control valve 624A, 624B on a respective expansion bypass line 621A, 621B.

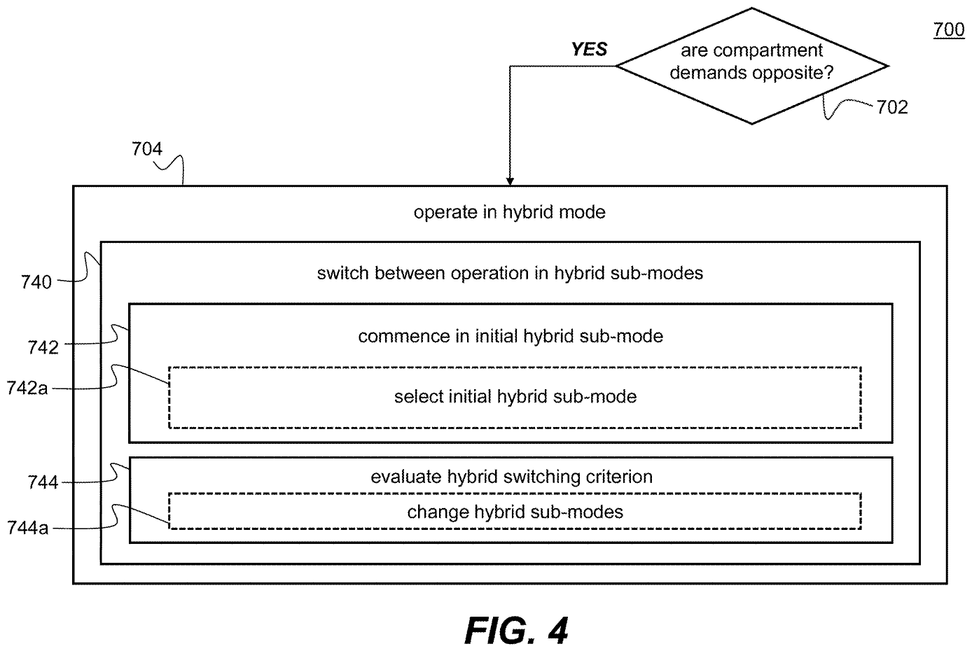

FIG. 4 is a flowchart which shows an example method 700 of operating the refrigeration circuit 400 of the first example RVCRS 110 described above with reference to FIGS. 2 and 3. In use, the method 700 is carried out by the controller 409.

The method 700 includes, at block 702, determining whether the first compartment demand and the second compartment demand are opposites such that one of the compartments 24A, 24B is a heating compartment 24A, 24B and the other of the compartments 24A, 24B is a cooling compartment 24A, 24B. If it is determined, at block 702, that the compartment demands are opposites, the method 700 includes proceeding to, at block 704, operating the RVCRS 110 in a hybrid mode. However, if it is determined, at block 702, that the compartment demands are not opposites, the method 700 may include proceeding to operating the RVCRS 110 in another mode (not shown).

Operating in the hybrid mode includes, at block 740, alternately switching between a plurality of hybrid sub-modes. The plurality of hybrid sub-modes includes a hybrid cooling sub-mode and a hybrid heating sub-mode. In the hybrid cooling sub-mode, the refrigeration circuit 400 is operated in the cooling circuit direction 202 (as shown by FIG. 2) and the heating section 600A, 600B is isolated to bias refrigerant flow to the cooling section 600A, 600B for cooling of the cooling compartment 24A, 24B. In the hybrid heating sub-mode, the refrigeration circuit 400 is operated in the heating circuit direction 204 (as shown by FIG. 3) and the cooling section 600A, 600B is isolated to bias refrigerant flow to the heating section 600A, 600B for heating of the heating compartment 24A, 24B.

In the hybrid cooling sub-mode, at least one of the control valves 624A, 624B, 632A, 632B of the heating section 600A, 600B is closed while all of the control valves 624A, 624B, 632A, 632B of the cooling section 600A, 600B are open. In the hybrid cooling sub-mode, isolation of the heating section 600A, 600B means that active heat transfer between refrigerant flow therethrough and the heating compartment 24A, 24B is effectively prevented (e.g., does not occur) whereas active heat transfer between refrigerant flow therethrough and the cooling compartment 24A, 24B takes place. Accordingly, in the hybrid cooling sub-mode, the cooling compartment 24A, 24B may be referred to as an active heat transfer compartment 24A, 24B and the heating compartment 24A, 24B may be referred to as an inactive heat transfer compartment 24A, 24B.

In the hybrid heating sub-mode, at least one (e.g., all) of the control valves 624A, 624B, 632A, 632B of the cooling section 600A, 600B is (e.g., are) closed while all of the control valves 624A, 624B, 632A, 632B of the heating section 600A, 600B are open. In the hybrid heating sub-mode, isolation of the cooling section 600A, 600B means that active heat transfer between refrigerant flow therethrough and the cooling compartment 24A, 24B is inhibited (e.g., prevented so that the refrigerant flow does not occur) whereas active heat transfer between refrigerant flow therethrough and the heating compartment 24A, 24B takes place. Accordingly, in the hybrid heating sub-mode, the heating compartment 24A, 24B may be referred to as an active heat transfer compartment 24A, 24B and the cooling compartment 24A, 24B may be referred to as an inactive heat transfer compartment 24A, 24B.

Switching, at block 740, between operation in the hybrid sub-modes therefore results in the identity of the active heat transfer compartment 24A, 24B and the inactive heat transfer compartment 24A, 24B being inverted.

Alternately switching, at block 740, between the hybrid cooling sub-mode and the hybrid heating sub-mode includes commencing, at block 742, operation in an initial hybrid sub-mode and evaluating, at block 744, a compartment hybrid switching criterion. The initial hybrid sub-mode may be either the hybrid cooling sub-mode or the hybrid heating sub-mode.

Depending on the evaluation, at block 744, of the compartment hybrid switching criterion, the method 700 may include, at sub-block 744a, switching (e.g., changing) between the hybrid sub-modes.

The compartment hybrid switching criterion may be determined so that switching, at sub-block 744a, occurs following a determination that a target temperature for the active heat transfer compartment is met. The target temperature may be a limit of a target temperature range. The limit of the target temperature range may be a maximum of the target temperature range when switching from the hybrid heating sub-mode, and may be a minimum of the target temperature range when switching from the hybrid cooling sub-mode. This may be referred to as a “first-in first-out” compartment hybrid switching criterion definition.

The compartment hybrid switching criterion may be determined so that switching, at sub-block 744a, occurs based on determining a change in the greatest of the first and second offsets. Namely, switching between the hybrid sub-modes occurs such the active heating compartment is the compartment associated with a greatest of the first and second offsets. This may be referred to as a “temperature gap versus set point” compartment hybrid switching criterion definition.

The compartment hybrid switching criterion may be determined so that switching, at sub-block 744a, occurs based on one of the hybrid sub-modes being a prioritized hybrid sub-mode and the other of the hybrid sub-modes being a deprioritized hybrid sub-mode. This may be referred to as a “relative priority” compartment hybrid switching criterion definition.

If so, the prioritized hybrid sub-mode is associated with a prioritized target temperature range and the respective compartment is a prioritized compartment while the deprioritized hybrid sub-mode is associated with a deprioritized target temperature range and the respective compartment is a deprioritized compartment. By way of example, if the prioritized hybrid sub-mode is the hybrid heating sub-mode, the heating compartment is the prioritized compartment and the cooling compartment is the deprioritized compartment.

The compartment hybrid switching criterion is determined such that switching, at sub-block 744a, from the prioritized hybrid sub-mode to the deprioritized hybrid sub-mode occurs if a target temperature for the prioritized compartment 24A, 24B (e.g., a prioritized target temperature) is met. Moreover, the compartment hybrid switching criterion is determined such that switching, at sub-block 744a, from the deprioritized hybrid sub-mode to the prioritized hybrid sub-mode occurs if: (i) a target temperature for the deprioritized compartment 24A, 24B (e.g., a prioritized target temperature) is met; or (ii) a limit of the prioritized target temperature range is reached (e.g., a prioritized limit temperature).

In this way, the definition of the compartment hybrid switching criterion relatively prioritizes the prioritized hybrid sub-mode and switches to the prioritized hybrid sub-mode to maintain the temperature of the prioritized compartment 24A, 24B within the prioritized target temperature range even if, for example, the temperature of the deprioritized compartment 24A, 24B is not yet within the deprioritized target temperature range.

Commencing, at block 742, operation in an initial hybrid sub-mode may include selecting, at sub-block 742a, the initial hybrid sub-mode. It may be that the initial hybrid sub-mode is selected, at sub-block 742a, as the prioritized hybrid sub-mode and therefore alternately switching, at block 740, between the hybrid cooling sub-mode and the hybrid heating sub-mode includes commencing, at block 742, operation in prioritized hybrid sub-mode and switching, at sub-block 744a, between the prioritized hybrid sub-mode and the deprioritized hybrid sub-mode as discussed above.

Alternatively, the initial hybrid sub-mode may be selected, at sub-block 742a, based on determining a greater of the first offset and the second offset. Namely, the initial hybrid sub-mode may be selected as the hybrid sub-mode associated with the compartment demand (and the compartment 24A, 24B) associated with the greater of the first offset and the second offset. As an example, if the first offset is greater than the second offset and the first compartment 24A is the heating compartment, the initial hybrid sub-mode may be selected, at sub-block 742a, as the hybrid heating sub-mode. As another example, if the second offset is greater than the first offset and the second compartment 24B is the cooling compartment, the initial hybrid sub-mode may be selected, at sub-block 742a, as the hybrid cooling sub-mode.

Otherwise, it may be that the initial hybrid sub-mode is predetermined and selecting, at sub-block 742a, the initial hybrid sub-mode includes retrieving the initial hybrid sub-mode (e.g., from a memory of the controller 409). Specifically, it may be that the initial hybrid sub-mode is predetermined as the hybrid cooling sub-mode or the hybrid heating sub-mode.

When the first compartment demand and the second compartment demand are for heating (such that both compartments are heating compartments), an attempt to operate both compartments simultaneously for heating when there is a difference in the first and second temperature set points may lead to adverse effects in the refrigeration circuit, which are mitigated in the refrigeration circuit control and operation as described below. These adverse effects may include a biasing of refrigerant flow to the heat exchanger section with the lower temperature set point, which may adversely bias capacity to the respective heat exchanger section. Further, if the refrigeration circuit is operated so that both the indoor heat exchangers receive refrigerant at a common condensing pressure, the condensing pressure may be dictated by the saturation temperature at the heat exchanger section associated with the lowest temperature set point. This may cause an adverse effect whereby the common condensing pressure and associated saturation temperature is below the set point of the heat exchanger section associated with the higher temperature set point, such that inadvertent cooling occurs at the respective heat exchanger section.

The disclosure envisages that operation of the example refrigeration circuits for simultaneous heating (i.e., when refrigerant flows through both heat exchanger sections for simultaneous heating of the respective compartments) is possible over a portion of an operating map for the refrigeration circuit (e.g., for a limited range of temperature set points), and the refrigeration circuit can be operated or configured to either extend the operating map for simultaneous heating, or to switch to alternate heating of the respective compartments. Examples and options for such operation and control are disclosed in the examples below.

Referring again to the refrigeration circuit of FIGS. 2 and 3 by way of example, the controller may be configured to operate the refrigeration circuit in a dual heating mode whereby refrigerant flows through both the first and second indoor heat exchanger sections 60A, 600B in respective first and second heating directions. The controller may be configured to control a bypass control valve 624A, 624B which bypasses the respective cooling expansion valve 622A, 622B to close in the dual heating mode, to thereby inhibit refrigerant flow through the respective heat exchanger section to provide a restricted refrigerant flow, while biasing refrigerant flow to the other refrigerant section. Operation in this mode may be referred to as operation in a restricted flow simultaneous heating mode. Refrigeration circuits according to the further examples herein can also be operated in the restricted flow simultaneous heating mode by corresponding control of the respective valves.

In an example, the second heat exchanger section 600B is associated with a relatively lower temperature set point than the first heat exchanger section 600A, and the controller is configured to close the bypass control valve 624B of the second heat exchanger section to bias the refrigerant flow to the first heat exchanger section 600A. Accordingly, a restricted refrigerant flow may pass through the second heat exchanger section 600B, for example as limited by the expansion valve 622B on the second primary connection portion 620A. The restriction of the refrigerant flow through the second heat exchanger section 600B may avoid a situation as described above whereby the condensing pressure and associated saturation temperature becomes lower than the temperature set point associated with the other (first) heat exchanger section 600A, while still permitting heating of the second compartment, thereby providing simultaneous heating in the dual heating mode.

The controller may be configured to open the bypass control valve 624B when operation in the dual heating mode for simultaneous heating ends, for example when operating the refrigeration circuit to meet a heating demand in only one of the compartments (e.g. whether there is a null demand in the other compartment, or a cooling demand for operation in the hybrid mode as discussed above).

Examples below include disclosure of operating in a simultaneous heating mode of the dual heating mode (for example, prior to switching between heating modes). Such operation in the simultaneous heating mode can additionally or alternatively comprise operating in the restricted flow simultaneous heating mode as discussed above.

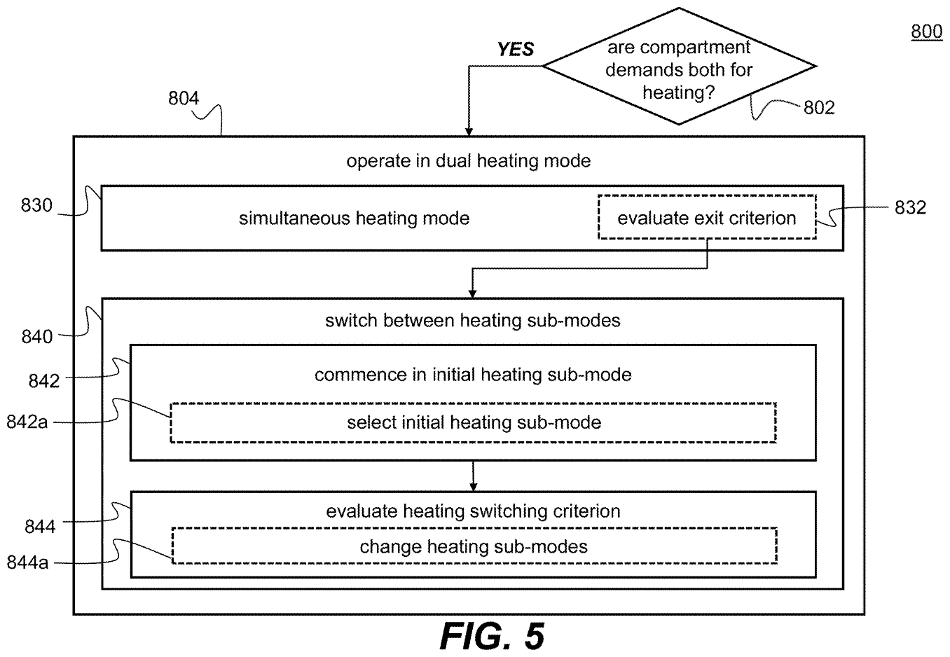

FIG. 5 is a flowchart which shows a further example method 800 of operating the refrigeration circuit 400 of the first example RVCRS 110 described above with reference to FIGS. 2 and 3. In use, the method 800 is carried out by the controller 409.

The method 800 includes, at block 802, determining whether the first compartment demand and the second compartment demand are both for heating such that each of the compartments 24A, 24B is a heating compartment 24A, 24B. If it is determined, at block 802, that the compartment demands are both for heating (e.g., are heating demands), the method 800 includes proceeding to, at block 804, operating the RVCRS 110 in a dual heating mode. However, if it is determined, at block 802, that the compartment demands are not both for heating, the method 800 may include proceeding to operating the RVCRS 110 in another mode (not shown).

Operating, at block 804, in the dual heating mode may include, at block 830, operating in a simultaneous heating mode. In the simultaneous heating mode, the refrigeration circuit 400 is operated in the heating circuit direction 204 (as shown by FIG. 3) and neither the first heat exchanger section 600A nor the second heat exchanger section 600B is isolated such that refrigerant flow is freely permitted through each heat exchanger section 600A, 600B for heating of the respective compartments 24A, 24B. In the simultaneous heating sub-mode, the control valves 624A, 624B, 632A, 632B of the each indoor heat exchanger section 600A, 600B are all open. As an alternative, the refrigeration circuit 400 may be operated in a restricted flow simultaneous heating mode.

Operating, at block 830, in the simultaneous heating mode (or restricted flow simultaneous heating mode) may include evaluating, at sub-block 832, an exit criterion (e.g., a simultaneous heating exit criterion). If it is evaluated, at sub-block 832, that the exit criterion has not been met, the method 800 includes continuing to operate, at block 830, in the simultaneous heating mode. However if it is evaluated, at sub-block 832, that the exit criterion has been met, the method 800 includes proceeding to alternately switching, at block 840, between a plurality of heating sub-modes as described in further detail below.

It may be evaluated, at sub-block 832, that the exit criterion has been met if it is determined that:
(a) one of the first and second compartments 24A, 24B is being cooled despite the heating demand (e.g., a demand inversion event has occurred);
(b) an imbalance of refrigerant flow through the first and second indoor heat exchanger sections 600A, 600B is above a flow imbalance threshold (e.g., that a threshold imbalance of refrigerant flow between the heat exchanger sections 600A, 600B exists);
(c) a common condensing pressure for the first and second heat exchanger sections is below a pressure threshold corresponding to simultaneous heating of the compartments 24A, 24B; and/or
(d) a refrigerant temperature is below a temperature threshold corresponding to simultaneous heating of the compartments 24A, 24B.
The common condensing pressure of (c) may be monitored using an appropriate pressure sensor located within the refrigeration circuit 400 (e.g., between the condensers 610A, 610B and the heating XV 522). The pressure threshold is related to a condensing temperature for (e.g., which is capable of providing) simultaneous heating of the compartments 24A, 24B. The refrigerant temperature of (d) may be monitored using one or more appropriate temperature sensors at or upstream of either condenser 610A, 610B within the respective indoor heat exchanger section 600A, 600B.

The flow imbalance threshold, the pressure threshold and the temperature threshold may each be referred to as exit criterion thresholds. It may be that each exit criterion threshold is predetermined or is determined based on the target temperatures for the compartments 24A, 24B (e.g., based on the lowest target temperature). The exit criterion thresholds may be defined such that, when the relevant thresholds are crossed, simultaneous heating of both compartments 24A, 24B is not considered to be thermodynamically possible in view of the conditions within the refrigeration circuit 400. Optionally, the exit criterion thresholds may be defined to include a safety/error margin such that the relevant thresholds being crossed is not necessarily indicative of simultaneous heating of both compartments 24A, 24B being thermodynamically impossible (but, in near-future, may no longer be possible).

The plurality of heating sub-modes includes a first heating sub-mode and a second heating sub-mode. In each heating sub-mode, the refrigeration circuit 400 is operated in the heating direction (as shown by FIG. 3). In the first heating sub-mode, the second heat exchanger section 600B is isolated to bias refrigerant flow to the first heat exchanger section 600A for heating of the first compartment 24A. But, in the second heating sub-mode, the first heat exchanger section 600A is isolated to bias refrigerant flow to the second heat exchanger section 600B for heating of the second compartment 24B.

In the first heating sub-mode, at least one of the control valves 624B, 632B of the second heat exchanger section 600B is closed while all of the control valves 624A, 632A of the first heat exchanger section 600A are open. In the first heating sub-mode, isolation of the second heat exchanger section 600B means that active heat transfer between refrigerant flow therethrough and the second compartment 24B is effectively prevented (e.g., does not occur) whereas active heat transfer between refrigerant flow therethrough and the first compartment 24A takes place. Accordingly, in the first heating sub-mode, the first compartment 24A may be referred to as an active heat transfer compartment 24A and the second compartment 24B may be referred to as an inactive heat transfer compartment 24B.

In the second heating sub-mode, at least one of the control valves 624A, 632A of the first heat exchanger section 600A is closed while all of the control valves 624B, 632B of the second heat exchanger section 600B are open. In the second heating sub-mode, isolation of the first heat exchanger section 600A means that active heat transfer between refrigerant flow therethrough and the first compartment 24A is effectively prevented (e.g., does not occur) whereas active heat transfer between refrigerant flow therethrough and the second compartment 24B takes place. Accordingly, in the second heating sub-mode, the second compartment 24B may be referred to as an active heat transfer compartment 24B and the first compartment 24A may be referred to as an inactive heat transfer compartment 24A.

Switching, at block 840, between operation in the heating sub-modes therefore results in the identity of the active heat transfer compartment 24A, 24B and the inactive heat transfer compartment 24A, 24B being inverted.

Alternately switching, at block 840, between the first heating sub-mode and the second heating sub-mode includes commencing, at block 842, operation in an initial heating sub-mode and evaluating, at block 844, a compartment heating switching criterion. The initial heating sub-mode may be either the first heating sub-mode or the second heating sub-mode.

Depending on the evaluation, at block 844, of the compartment heating switching criterion, the method 800 may include, at sub-block 844a, switching (e.g., changing) between the heating sub-modes.

The compartment heating switching criterion may be determined so that switching, at sub-block 844a, occurs following a determination that a target temperature for the active heat transfer compartment is met. The target temperature may be a limit of a target temperature range. The limit of the target temperature range may be a maximum of the target temperature range when switching from the first heating sub-mode, and may be a minimum of the target temperature range when switching from the second heating sub-mode. This may be referred to as a “first-in first-out” compartment heating switching criterion definition.

The compartment heating switching criterion may be determined so that switching, at sub-block 844a, occurs based on determining a change in the greatest of the first and second offsets. Namely, switching between the heating sub-modes occurs such the active heating compartment is the compartment associated with a greatest of the first and second offsets. This may be referred to as a “temperature gap versus set point” compartment heating switching criterion definition.

The compartment heating switching criterion may be determined so that switching, at sub-block 844a, occurs based on one of the heating sub-modes being a prioritized heating sub-mode and the other of the heating sub-modes being a deprioritized heating sub-mode. This may be referred to as a “relative priority” compartment heating switching criterion definition.

If so, the prioritized heating sub-mode is associated with a prioritized target temperature range and the respective compartment is a prioritized compartment while the deprioritized heating sub-mode is associated with a deprioritized target temperature range and the respective compartment is a deprioritized compartment. By way of example, if the prioritized heating sub-mode is the first heating sub-mode, the first compartment is the prioritized compartment and the second compartment is the deprioritized compartment.

The compartment heating switching criterion is determined such that switching, at sub-block 844a, from the prioritized heating sub-mode to the deprioritized heating sub-mode occurs if a target temperature for the prioritized compartment 24A, 24B (e.g., a prioritized target temperature) is met. Moreover, the compartment heating switching criterion is determined such that switching, at sub-block 844a, from the deprioritized heating sub-mode to the prioritized heating sub-mode occurs if: (i) a target temperature for the deprioritized compartment 24A, 24B (e.g., a prioritized target temperature) is met; or (ii) a limit of the prioritized target temperature range is reached (e.g., a prioritized limit temperature).

In this way, the definition of the compartment heating switching criterion relatively prioritizes the prioritized heating sub-mode and switches to the prioritized heating sub-mode to maintain the temperature of the prioritized compartment 24A, 24B within the prioritized target temperature range even if, for example, the temperature of the deprioritized compartment 24A, 24B is not within the deprioritized target temperature range.

Commencing, at block 842, operation in an initial heating sub-mode may include selecting, at sub-block 842a, the initial heating sub-mode. It may be that the initial heating sub-mode is selected, at sub-block 842a, as the prioritized heating sub-mode and therefore alternately switching, at block 840, between the heating cooling sub-mode and the heating sub-mode includes commencing, at block 842, operation in prioritized heating sub-mode and switching, at sub-block 844a, between the prioritized heating sub-mode and the deprioritized heating sub-mode as discussed above.

Alternatively, the initial heating sub-mode may be selected, at sub-block 842a, based on determining a greater of the first offset and the second offset. Namely, the initial heating sub-mode may be selected as the heating sub-mode associated with the compartment demand (and the compartment 24A, 24B) associated with the greater of the first offset and the second offset. As an example, if the first offset is greater than the second offset, the initial heating sub-mode may be selected, at sub-block 842a, as the first heating sub-mode. As another example, if the second offset is greater than the first offset, the initial heating sub-mode may be selected, at sub-block 842a, as the second heating sub-mode.

Otherwise, it may be that the initial heating sub-mode is predetermined and selecting, at sub-block 842a, the initial heating sub-mode includes retrieving the initial heating sub-mode (e.g., from a memory of the controller 409). Specifically, it may be that the initial heating sub-mode is predetermined as the first heating sub-mode or the second heating sub-mode.

FIGS. 6 and 7 are diagrams of a second example RVCRS 110′ suitable for use as the RVCRS 110 within the vehicle 10 and the multi-compartment refrigeration unit 20 of FIG. 1. The second example RVCRS 110′ is generally similar to the first example RVCRS 110 described above with reference to FIGS. 2 and 3, with like reference signs denoting common or similar features. Nevertheless, in the second example RVCRS 110′ shown by FIGS. 6 and 7, an additional secondary one-way valve 636A′, 636B′ is disposed along the secondary upper branch 633A, 633B and an additional pressure regulating valve 634A′, 634B′ is disposed along the secondary lower branch 631A, 631B.

The secondary one-way valves 636A, 636A are opposingly biased such that, in use, the action of the secondary one-way valve 636A, 636B inhibits (e.g., prevents) flow of refrigerant along the secondary lower branch 631A, 631B while the refrigerant circuit 400 is operated in the cooling circuit direction 202 whereas the additional secondary one-way valve 636A′, 636B′ inhibits (e.g., prevents) flow of refrigerant along the secondary upper branch 633A, 633B while the refrigerant circuit 400 is operated in the heating circuit direction 204. Accordingly, refrigerant preferentially flows along the secondary upper branch 633A, 633B while the refrigerant circuit 400 is operated in the cooling circuit direction 202 such that the secondary upper branch 633A, 633B is the secondary cooling direction branch 633A, 633B and refrigerant preferentially flows along the secondary lower branch 631A, 631B while the refrigerant circuit 400 is operated in the heating circuit direction 204 such that the secondary lower branch 631A, 631B is the secondary heating direction branch 631A, 631B.

FIGS. 8 and 9 are diagrams of a third example RVCRS 110″ suitable for use as the RVCRS 110 within the vehicle 10 and the multi-compartment refrigeration unit 20 of FIG. 1. The third example RVCRS 110″ is generally similar to the first example RVCRS 110 described above with reference to FIGS. 2 and 3 and to the second example RVCRS 110′ described above with reference to FIGS. 6 and 7, with like reference signs denoting common or similar features. However, in the third example RVCRS 110″, the secondary control valve 632A, 632B is disposed along the secondary upper branch 633A, 633B and the secondary connection portion 630A, 630B of each indoor heat exchanger section 600A, 600B comprises a restriction (e.g., a fixed flow restrictor or a capillary) 638A, 638B disposed along the along the secondary lower branch 631A, 631B, which is therefore fluidically connected in parallel with the secondary control valve 632A, 632B. It some examples, only one of the indoor heat exchanger sections 600A, 600B comprises a restrictor 638A, 638B.

The additional pressure regulating valve 634A′, 634B′ of the second example RVCRS 110′ and the restriction 638A, 638B of the third example RVCRS 110″ may each be referred to as restrictor devices. The one-way valves in the second connection portion 630A, 630B of the example RVCRS 110, 110′ 110″ described herein may be check valves, and may be referred to as one-way flow control devices.

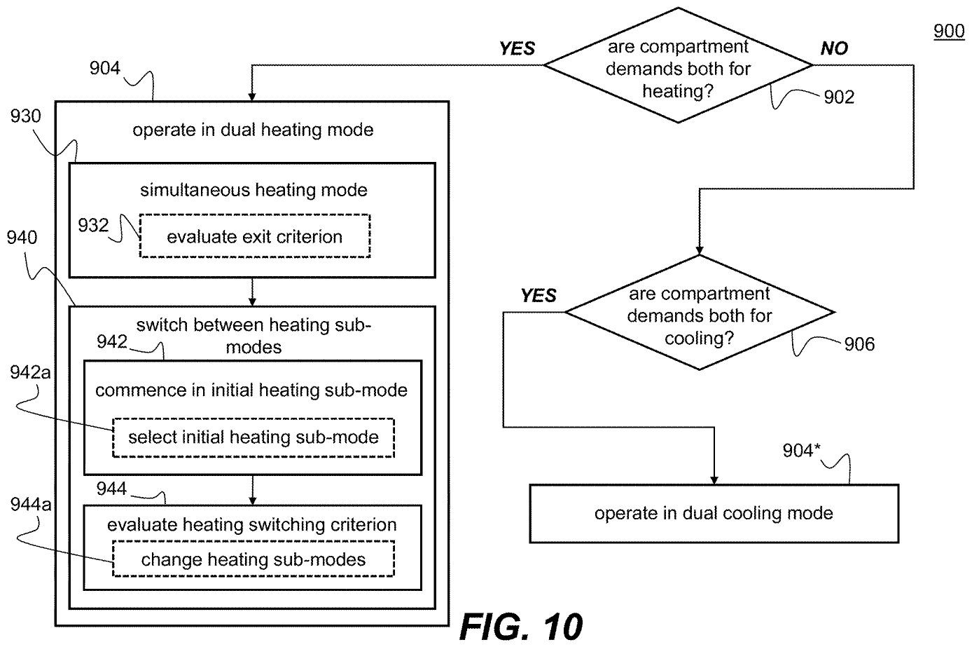

FIG. 10 is a flowchart which shows an example method 900 of operating the refrigeration circuit 400 of the second example RVCRS 110′ described above with reference to FIGS. 6 and 7 or the refrigeration circuit 400 of the third example RVCRS 110″ described above with reference to FIGS. 8 and 9. In use, the method 900 is carried out by the controller 409. In the context of the method 900, the first and second temperature targets are different such that the first target temperature is greater than the second target temperature. For example, the first target temperature may be around 4 °C (for fresh goods storage) and the second target temperature may be around −20 °C (for frozen goods storage). Hence the first compartment 24A may be referred to as the fresh compartment 24A or the higher-temperature compartment 24A and the second compartment 24B may be referred to as the frozen compartment 24B or the lower-temperature compartment 24B. In addition, the first indoor heat exchanger section 600A may be referred to as the higher-temperature section 600A and the second indoor heat exchanger section 600B may be referred to as the lower-temperature section 600B.

The method 900 includes, at block 902, determining whether the first compartment demand and the second compartment demand are both for heating such that each of the compartments 24A, 24B is a heating compartment 24A, 24B. If it is determined, at block 902, that the compartment demands are both for heating (e.g., are heating demands), the method 900 includes proceeding to, at block 904, operating the RVCRS 110′, 110″ in a dual heating mode. However, if it is determined, at block 902, that the compartment demands are not both for heating, the method 900 may includes proceeding, at block 906, to determining whether the first compartment demand and the second compartment demand are both for cooling such that each of the compartments 24A, 24B is a cooling compartment 24A, 24B. If it is determined, at block 902, that the compartment demands are both for cooling (e.g., are cooling demands), the method 900 includes proceeding to, at block 904*, operating the RVCRS 110′, 110″ in a dual cooling mode. However, if it is determined, at block 906, that the compartment demands are not both for cooling, the method 900 may include proceeding to operating the RVCRS 110′, 110″ in another mode (not shown).

Operating, at block 904, in the dual heating mode of the method 900 is generally similar to operating, at block 804, in the deal heating mode of the method 800, with corresponding reference signs denoting corresponding actions. Namely, block 940 of the method 900 corresponds to block 840 of the method 800 and sub-blocks 932, 942, 942a, 944 and 944a of the method 900 correspond to sub-blocks 832, 842, 842a, 844 and 844a of the method 800.

More specifically, the method 900 may include alternately switching, at block 940, between the plurality of heating sub-modes described above with respect to block 840 of the method 800 so as to selectively isolate one of the first and second indoor heat exchanger sections 600A, 600B in the dual heating mode using a respective isolating flow control device (e.g., a first or second isolating flow control device) in response to determining that a demand inversion event has occurred (i.e., an event corresponding to cooling of one of the first and second compartments 24A, 24B despite a demand for heating, as discussed with respect to (d) above). The isolating flow control device of each indoor heat exchanger sections 600A, 600B may be, for example, the secondary control valves 632A, 632B of the second example RVCRS 110′, which not disposed on (e.g., are located outside of) the parallel upper and lower secondary branches 631A, 631B, 633A, 633B.

Further, the differences between the simultaneous heating mode 930 of the method 900 and the simultaneous heating mode 830 of the method 800 will become apparent in view of the description provided below.

When operating, at block 904, in the dual heating mode, refrigerant flows through the first indoor heat exchanger section 600A and the second indoor heat exchanger section 600B in respective first and second heating directions so that the first and second secondary connection portions 630A, 630B are upstream of the respective indoor heat exchangers 610A, 610B as shown by FIGS. 7 and 9.

Conversely, when operating, at block 904*, in the dual cooling mode, refrigerant flows through the first indoor heat exchanger section 600A and the second indoor heat exchanger section 600B in the respective first and second cooling directions so that the first and second secondary connection portions 630A, 630B are downstream of the respective indoor heat exchangers 610A, 610B as shown by FIGS. 6 and 8. The first and second heating directions oppose the first and second cooling directions.

The refrigeration circuit 400 is configured so that a flow factor along the second secondary connection portion 630B in the second heating direction is lower than a flow factor along the first secondary connection portion 630A in the first heating direction while in operating, at block 930, in the simultaneous heating mode of the dual heating mode.

Namely, with reference to the second example RVCRS 110′ described above with reference to FIGS. 6 and 7, operating in the simultaneous heating mode of the dual heating mode includes the additional one-way valve 636A′, 636B′ acting to prevent refrigerant flow along the secondary upper branch 633A, 633B and thus to direct refrigerant flow along the secondary lower branch 631A, 631B. In this way, each additional one-way valve 636A′, 636B′ functions as a cooling branch flow control device 636A′, 636B′ configured to close in the simultaneous heating mode of the dual heating mode to direct refrigerant along the respective heating direction branch 633A, 633B. The additional pressure regulating valves 634A′, 634B′ determine the flow factor through the secondary connection portions 630B, 630A in the simultaneous heating mode of the dual heating mode.

With reference to the third example RVCRS 110″ described above with reference to FIGS. 8 and 9, operating in the simultaneous heating mode of the dual heating mode includes closing the secondary control valve 632B of at least the second indoor heat exchanger section 600B such that refrigerant flow along the second secondary upper branch 633B is prevented and refrigerant is directed to flow along the second secondary lower branch 631B and through the restriction 638B. Operating in the simultaneous heating mode of the dual heating mode may also include opening the secondary control valve 632A of the first indoor heat exchanger section 600A such that refrigerant flow along the first secondary upper branch 633A is permitted and thus, in use, refrigerant preferentially flows along the first secondary upper branch 633A. It follows that, in the simultaneous heating mode of the dual heating mode and in the third example RVCRS 110″, the second secondary lower branch 631B is a second heating direction branch while the first secondary upper branch 633A is a first heating direction branch. A resistance to flow provided by the restriction 638B ensures that the flow factor along the second secondary connection portion 630B in the second heating direction is lower than the flow factor along the first secondary connection portion 630A in the first heating direction. In this manner, the restriction 638B determines the flow factor along the first secondary connection portion 630A in the first heating direction.

As a result, when operating in the simultaneous heating mode of the dual heating mode at block 904, refrigerant received by the first and second indoor heat exchanger sections 600A, 600B from the compressor 402 is expanded relatively more in the second secondary connection portion 630B, such that a condensing pressure (and therefore a condensing temperature) at the second heat exchanger 610B is relatively lower than a condensing pressure (and therefore a condensing temperature) at the first heat exchanger 610A. This permits compartment heating to occur at both heat exchangers 610A, 610B and avoids a situation which may occur whereby a common condensing pressure is established at both heat exchangers 610A, 610B which causes heating of the second compartment 24B (e.g., the frozen compartment 24B) but also causes unintended cooling of the first compartment 24A (e.g., the fresh compartment 24A).

The refrigeration circuit 400 is configured so that a flow factor along at least one of (e.g., each of) the secondary connection portions 630A, 630B in the respective heating direction while operating, at block 904, in the dual heating mode is different from a flow factor along the secondary connection portion 630A, 630B (i.e., the same secondary connection portion) in the respective cooling direction while operating, at block 904*, in the dual cooling mode.

Namely, with reference to the second example RVCRS 110′ described above with reference to FIGS. 6 and 7, operating in the dual cooling mode includes the one-way valve 636A, 636B acting to prevent refrigerant flow along the secondary lower branch 631A, 631B and thus to direct refrigerant flow along the secondary upper branch 633A, 633B. In this way, each one-way valve 636A, 636B functions as a heating branch flow control device 636A, 636B configured to close in the dual cooling mode to direct refrigerant along the secondary upper branch 633A, 633B. Hence the pressure regulating valves 634A, 634B determine the flow factor through the secondary connection portions 630B, 630A in the dual cooling mode.

A setting of the pressure regulating valve 634A, 634B of each secondary connection portion 630A, 630B differs from a corresponding setting of the additional pressure regulating valve 634A′, 634B′ of the same secondary connection portion 630A, 630B such that the flow factor along the secondary connection portion 630A, 630B in the heating direction (e.g., in the simultaneous heating mode of the dual heating mode) differs from the flow factor along the secondary connection portion 630A, 630B in the cooling direction (e.g., in the dual cooling mode). Conversely, a setting of the first additional pressure regulating valve 634A′ differs from a corresponding setting of the second additional pressure regulating valve 634B′ such that the flow factor along the second secondary connection portion 630B in the second heating direction is lower than the flow factor along the first secondary connection portion 630A in the first heating direction.

Due to the functionality described above with references to FIGS. 6 and 7, the one-way flow control valves 636A, 636B of the first and second secondary connection portions 630A, 630B may be described as first and second heating branch flow control devices 636A, 636B, respectively, while the additional one-way flow control valves 636A′, 636B′ of the first and second secondary connection portions 630A, 630B may be described as first and second cooling branch flow control devices 636A′, 636B′, respectively.

Due to the functionality described above with references to FIGS. 8 and 9, the first secondary control valve 632A of the third example RVCRS 110″ may be referred to as a first heating branch flow control device 632A while the second secondary control valve 632B of the third example RVCRS 110″ may be referred to as a second cooling branch flow control device 632B.

Moreover, the refrigeration circuit 400 is configured so that the flow factor along the first secondary connection portion 630A in the first cooling direction is lower than a flow factor along the second secondary connection portion 630B in the second cooling direction while in operating, at block 904*, in the dual cooling mode.

Specifically, with reference to the second example RVCRS 110′ described above with reference to FIGS. 6 and 7, operating in the dual cooling mode includes the one-way valve 636A, 636B acting to prevent refrigerant flow along the secondary lower branch 631A, 631B and thus to direct refrigerant flow along the secondary upper branch 633A, 633B. A setting of the first pressure regulating valve 634A differs from a corresponding setting of the second pressure regulating valve 634B such that the flow factor along the first secondary connection portion 630A in the first cooling direction is lower than the flow factor along the second secondary connection portion 630B in the second cooling direction.

With reference to the third example RVCRS 110″ described above with reference to FIGS. 8 and 9, operating in the dual cooling mode includes closing the secondary control valve 632A of at least the first indoor heat exchanger section 600A such that refrigerant flow along the first secondary upper branch 633A is prevented and refrigerant is directed to flow along the first secondary lower branch 631A and through the restriction 638A. Operating in the dual cooling mode may also include opening the secondary control valve 632B of the second indoor heat exchanger section 600B such that refrigerant flow along the second secondary upper branch 633B is permitted and thus, in use, refrigerant preferentially flows along the second secondary upper branch 633B. It follows that, in the dual cooling mode and in the third example RVCRS 110″, the second secondary upper branch 633B is a second cooling direction branch while the first secondary lower branch 631A is a first cooling direction branch. A resistance to flow provided by the restriction 638A ensures that the flow factor along the first secondary connection portion 630A in the first cooling direction is lower than the flow factor along the second secondary connection portion 630B in the second cooling direction. In this manner, the restriction 638A determines the flow factor along the first secondary connection portion 630A in the first cooling direction.

As a result, in the dual cooling mode, an evaporation pressure at the first heat exchanger 610A may be elevated from a common suction pressure at which refrigerant is returned to the compressor 402 by relatively more than a corresponding evaporation pressure at the second heat exchanger 610B. In other words, the evaporation pressure at the first heat exchanger 610A may be greater than the evaporation pressure at the second heat exchanger 610B by virtue of there being a greater pressure drop to the common suction pressure over the first secondary connection portion 630A than over the second secondary connection portion 630B, in turn owing to the relatively lower flow factor on the first secondary connection portion 630A.

As used herein, the term flow factor corresponds to non-zero refrigerant flow operating conditions. For example, where control valves are provided that may selectively permit or prevent flow, the flow factor is determined for operating conditions at which refrigerant flows in the respective direction (e.g., is not entirely prevented by a control valve).

Although it has been described that each indoor heat exchanger section 600A, 600B comprises both a primary control valve 624A, 624B and a secondary control valve 632A, 632B, this need not necessarily be the case. For example, it may be that each indoor heat exchanger section 600A, 600B comprises only a secondary control valve 632A, 632B as described herein. Alternatively, it may be that each indoor heat exchanger section 600A, 600B comprises only a primary control valve 624A, 624B as described herein. If so, it may be that closing of the primary control valve 624A, 624B results in refrigerant flow through the respective section being heavily restricted (e.g., isolated, even if some small amount of refrigerant flow through the cooling expansion valve 622A, 622B occurs).

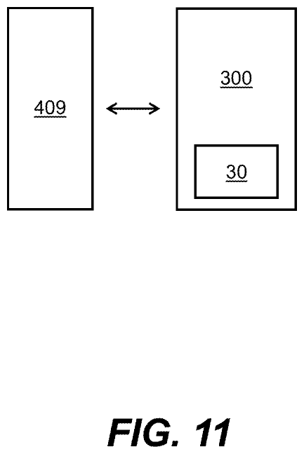

FIG. 11 shows, highly schematically, a non-transitory computer-readable (e.g., machine-readable) medium 300 having stored thereon a computer program 30 comprising instructions which, when executed by a controller of an RVCRS in accordance with any of the example RVCRS 110, 110′, 110″ described above (e.g., the controller 409), cause the controller to execute (e.g., carry out) a method 700, 800, 900 as described above with reference to FIG. 4, 5 or 10. The computer program 30 may be software or firmware or be a combination of software and firmware.

Except where mutually exclusive, a feature described in relation to any one of the above aspects may be applied mutatis mutandis to any other aspect. Furthermore, except where mutually exclusive, any feature described herein may be applied to any aspect and/or combined with any other feature described herein. Moreover, while the present disclosure is made with in the context of transport refrigeration systems and/or vapor-compression circuits, it will be appreciated that the present disclosure has other possible applications in other technical areas.

The controller(s) described herein may comprise a processor. The controller and/or the processor may comprise any suitable circuity to cause performance of the methods described herein and as illustrated in the drawings. The controller or processor may comprise: at least one application specific integrated circuit (ASIC); and/or at least one field programmable gate array (FPGA); and/or single or multi-processor architectures; and/or sequential (Von Neumann)/parallel architectures; and/or at least one programmable logic controllers (PLCs); and/or at least one microprocessor; and/or at least one microcontroller; and/or a central processing unit (CPU), to perform the methods and or stated functions for which the controller or processor is configured.

1. A reversible vapour-compression refrigeration system for a multi-compartment refrigeration unit, the refrigeration system comprising:
a refrigeration circuit including a compressor, an outdoor heat exchanger section, a first indoor heat exchanger section for a first compartment and a second indoor heat exchanger section for a second compartment, the first and second indoor heat exchanger sections provided along parallel paths to each other; and
a controller configured to operate the refrigeration circuit based on a first compartment demand for heating or cooling and a second compartment demand for heating or cooling, each compartment demand determined based on respective first and second target temperatures;
wherein the controller is configured to operate the refrigeration circuit in:
a cooling circuit direction to convey refrigerant from the compressor to the outdoor heat exchanger, and then to one or more of the first and second indoor heat exchanger sections for compartment cooling; and
a heating circuit direction to convey refrigerant from the compressor to one or more of the first and second indoor heat exchanger sections for compartment heating, and then to the outdoor heat exchanger section;
wherein the controller is configured to operate the refrigeration system in a hybrid mode when the first compartment demand and the second compartment demand are opposites, whereby:
one of the first and second compartment demands is a heating demand, the respective compartment is a heating compartment, and the respective indoor heat exchanger section is a heating section, and
the other of the first and second compartment demands is a cooling demand, the respective compartment is a cooling compartment, and the respective indoor heat exchanger section is a cooling section;
wherein the controller is configured to selectively isolate the heating section by closing a control valve of the heating section, and the controller is configured to selectively isolate the cooling section by closing a control valve of the cooling section;
wherein the controller is configured to operate in the hybrid mode by alternately switching between:
a hybrid heating sub-mode in which the controller operates the refrigeration circuit in the heating circuit direction and isolates the cooling section to bias refrigerant flow to the heating section for heating the heating compartment; and
a hybrid cooling sub-mode in which the controller operates the refrigeration circuit in the cooling circuit direction and isolates the heating section to bias refrigerant flow to the cooling section for cooling the cooling compartment.

2. The refrigeration system of claim 1, wherein the controller is configured so that:
in the hybrid heating sub-mode, the control valve of the heating section is open; and
in the hybrid cooling sub-mode, the control valve of the cooling section is open.

3. The refrigeration system of claim 1, wherein the controller is configured to switch alternately between the hybrid heating sub-mode and the hybrid cooling sub-mode to switch between the heating compartment and the cooling compartment being an active heat transfer compartment, wherein the alternate switching is based on evaluating a compartment hybrid switching criterion.

4. The refrigeration system of claim 3, wherein the compartment hybrid switching criterion is defined so that switching occurs based on determining that a target temperature for the active heat transfer compartment is met.

5. The refrigeration system of claim 3, wherein the controller is configured to:
monitor a first offset between a monitored temperature of the first compartment and an associated first target temperature;
monitor a second offset between a monitored temperature of the second compartment and an associated second target temperature; and
wherein the compartment hybrid switching criterion is defined so that switching of the active heat transfer compartment occurs based on determining a change in the greatest of the first and second offsets.

6. The refrigeration system of claim 3, wherein the controller is configured to commence alternate operation between the hybrid heating sub-mode and the hybrid cooling sub-mode by selecting one of the hybrid heating sub-mode and the hybrid cooling sub-mode as an initial hybrid sub-mode, wherein the controller is configured so that:
the initial hybrid sub-mode is predetermined; or
the initial hybrid sub-mode is determined based on determining the greater of a first offset between a monitored temperature of the heating compartment and an associated target temperature, and a second offset between a monitored temperature of the cooling compartment and an associated target temperature.

7. The refrigeration system of claim 3, wherein the compartment hybrid switching criterion is defined so that one of the hybrid heating sub-mode and the hybrid cooling sub-mode is a prioritized hybrid sub-mode, and the other is a deprioritized hybrid sub-mode;
wherein the prioritized hybrid sub-mode is associated with a prioritized target temperature range and the respective compartment is a prioritized compartment, and the deprioritized hybrid sub-mode is associated with a deprioritized target temperature range and the respective compartment is a deprioritized compartment;
wherein the compartment hybrid switching criterion is defined so that:
the controller switches from the prioritized hybrid sub-mode to the deprioritized hybrid sub-mode based on determining that a prioritized target temperature for the prioritized compartment is met;
the controller switches from the deprioritized hybrid sub-mode to the prioritized hybrid sub-mode based on any of:
determining that a deprioritized target temperature for the deprioritized compartment is met; and
determining that a limit of the prioritized target temperature range is reached.

8. A reversible vapour-compression refrigeration system for a multi-compartment refrigeration unit, the refrigeration system comprising:
a refrigeration circuit including a compressor, an outdoor heat exchanger section, a first indoor heat exchanger section for a first compartment and a second indoor heat exchanger section for a second compartment, the first and second indoor heat exchanger sections provided along parallel paths to each other;
a controller configured to operate the refrigeration circuit based on a first compartment demand for heating or cooling and a second compartment demand for heating or cooling, each compartment demand determined based on respective first and second target temperatures;
wherein the controller is configured to operate the refrigeration circuit in:
a cooling circuit direction to convey refrigerant from the compressor to the outdoor heat exchanger section, and then to one or more of the first and second indoor heat exchanger sections for compartment cooling; and
a heating circuit direction to convey refrigerant from the compressor to one or more of the first and second indoor heat exchanger sections for compartment heating, and then to the outdoor heat exchanger section;
wherein the controller is configured to operate the refrigeration circuit in a dual heating mode responsive to a first compartment heating demand and a second compartment heating demand, in which the refrigeration circuit operates in the heating circuit direction and both the first and second indoor heat exchanger sections operate as condensers for heating both the first and second;
wherein the controller is configured to selectively isolate the first heat exchanger section by closing a control valve of the first heat exchanger section, and the controller is configured to selectively isolate the second heat exchanger section by closing a control valve of the second heat exchanger section;
wherein the controller is configured to operate in the dual heating mode by alternately switching between:
a first heating sub-mode in which the controller isolates the second heat exchanger section to bias refrigerant flow to the first heat exchanger section for heating the first compartment; and
a second heating sub-mode in which the controller isolates the first heat exchanger section to bias refrigerant flow to the second heat exchanger section for heating the second compartment.

9. The refrigeration system of claim 8, wherein the controller is configured so that:
in the first heating sub-mode, the control valve of the first heat exchanger section is open; and
in the second heating sub-mode, the control valve of the second heat exchanger section is closed.

10. The refrigeration system of claim 8, wherein the controller is configured to switch alternately between the first heating sub-mode and the second heating sub-mode to switch between the first compartment and the second compartment being an active heat transfer compartment, wherein the alternate switching is based on evaluating a compartment heating switching criterion.

11. The refrigeration system of claim 10, wherein the controller is configured to:
monitor a first offset between a monitored temperature of the first compartment and an associated first target temperature;
monitor a second offset between a monitored temperature of the second compartment and an associated second target temperature; and
wherein the compartment heating switching criterion is defined so that switching of the active heat transfer compartment occurs based on determining a change in the greatest of the first and second offsets.

12. The refrigeration system of claim 10, wherein the controller is configured to commence alternate operation between the first heating sub-mode and the second heating sub-mode by selecting one of the first heating sub-mode and the second heating sub-mode as an initial heating sub-mode, wherein the controller is configured so that:
the initial heating sub-mode is predetermined; or
the initial heating sub-mode is determined based on determining the greater of a first offset between a monitored temperature of the first compartment and an associated target temperature, and a second offset between a monitored temperature of the second compartment and an associated target temperature.

13. The refrigeration system of claim 10, wherein the compartment heating switching criterion is defined so that one of the first heating sub-mode and the second heating sub-mode is a prioritized heating sub-mode, and the other is a deprioritized heating sub-mode;
wherein the prioritized heating sub-mode is associated with a prioritized target temperature range and the respective compartment is a prioritized compartment, and the deprioritized heating sub-mode is associated with a deprioritized target temperature range and the respective compartment is a deprioritized compartment;
wherein the compartment heating switching criterion is defined so that:
the controller switches from the prioritized heating sub-mode to the second sub-mode based on determining that a first target temperature for the first priority compartment is met;
the controller switches from the deprioritized heating sub-mode to the first priority sub-mode based on any of:
determining that a second target temperature for the deprioritized compartment is met; and
determining that a limit of the prioritized target temperature range is reached.

14. The refrigeration system of claim 8, wherein the controller is configured to operate in the dual heating mode by:
operating in a simultaneous heating mode in which the both the first and second heat exchanger sections are not isolated and refrigerant flow is permitted through both of the first and second heat exchanger sections for heating the respective first and second compartments; and
commencing alternate operation between the prioritized heating sub-mode and the second priority sub-mode based on evaluating an exit criterion.

15. The refrigeration system of claim 14, wherein the controller is configured to evaluate the exit criterion by:
determining cooling of one of the first and second compartments despite a heating demand;
determining an threshold imbalance of refrigerant flow;
monitoring a common condensing pressure for the first and second heat exchanger sections, and determining that the common condensing pressure is below a threshold corresponding to simultaneous heating of the compartments;
monitoring a refrigerant temperature, and determining that the refrigerant temperature is below a threshold corresponding to simultaneous heating of the compartments.

16. A reversible vapour-compression refrigeration system for a multi-compartment refrigeration unit, the refrigeration system comprising:
a refrigeration circuit including a compressor, an outdoor heat exchanger section, a first indoor heat exchanger section for a first compartment and a second indoor heat exchanger section for a second compartment, the first and second indoor heat exchanger sections provided along parallel paths to each other;
a controller configured to operate the refrigeration circuit based on a first compartment demand for heating or cooling and a second compartment demand for heating or cooling, each compartment demand determined based on respective first and second target temperatures;
wherein the controller is configured to operate the refrigeration circuit in:
a cooling circuit direction to convey refrigerant from the compressor to the outdoor heat exchanger, and then to one or more of the first and second indoor heat exchanger sections; and
a heating circuit direction to convey refrigerant from the compressor to one or more of the first and second indoor heat exchanger sections, and then to the outdoor heat exchanger section;
wherein the controller is configured to operate the refrigeration circuit in a dual cooling mode responsive to a first compartment cooling demand and a second compartment cooling demand, in which the refrigeration circuit operates in the cooling circuit direction and both the first and second indoor heat exchanger sections operate as evaporators for cooling both the first and second compartments;
wherein the controller is configured to operate the refrigeration circuit in a dual heating mode responsive to a first compartment heating demand and a second compartment heating demand, in which the refrigeration circuit operates in the heating circuit direction and both the first and second indoor heat exchanger sections operate as condensers for heating both the first and second compartments;
wherein the first indoor heat exchanger section comprises a first heat exchanger and a first connection portion for conveying refrigerant between the first heat exchanger and the outdoor heat exchanger, and the second indoor heat exchanger section comprises a second heat exchanger and a second connection portion for conveying refrigerant between the second heat exchanger and the outdoor heat exchanger;
wherein the controller is configured to operate the refrigeration circuit so that:
in the dual cooling mode, refrigerant flows through the first indoor heat exchanger section and the second indoor heat exchanger section in respective first and second cooling directions, so that the first and second connection portions are downstream of the first and second indoor heat exchangers, respectively;
in the dual heating mode, refrigerant flows through the first indoor heat exchanger section and the second indoor heat exchanger section in respective first and second heating directions which oppose the respective cooling directions, so that the first and second connection portions are upstream of the first and second indoor heat exchangers, respectively; and
wherein the first and second connection portions are configured so that a flow factor along the second connection portion in the second heating direction is lower than a flow factor along the first connection portion in the first heating direction.

17. The refrigeration system according to claim 16, wherein the second connection portion comprises two parallel branches, including a cooling direction branch for refrigerant flow in the second cooling direction, and a heating direction branch for refrigerant flow in the second heating direction; and
wherein the refrigeration circuit is configured so that a restrictor device in the heating direction branch of the second connection portion determines the flow factor along the second connection portion in the second heating direction.

18. The refrigeration system of claim 17, wherein the refrigeration circuit is configured so that the restrictor device in the heating direction branch of the second connection portion determines the flow factor along the second connection portion in the second heating direction by:
the cooling direction branch comprising a one-way flow control device configured to permit flow in the second cooling direction and to prevent flow in the second heating direction, to thereby direct refrigerant flow in the second heating direction along the heating direction branch; and/or
the cooling direction branch comprising a second cooling branch flow control device configured to close in the dual heating mode to direct refrigerant flow along the second connection portion to flow along the heating direction branch.

19. The refrigeration system of claim 17, configured so that the flow factor along the second connection portion in the second heating direction in the dual heating mode is different from a flow factor along the second connection portion in the second cooling direction in the dual cooling mode.

20. The refrigeration system of claim 17, wherein the first connection portion comprises two parallel branches, including a cooling direction branch for refrigerant flow in the first cooling direction, and a heating direction branch for refrigerant flow in the first heating direction;
wherein the refrigeration system is configured so that the flow factor along the first connection portion in the first heating direction in the dual heating mode is different from a flow factor along the first connection portion in the first cooling direction in the dual cooling mode.
